(19) United States
(12) Patent Application Publication
(10) Pub. No.: US 2017/0073898 A1
(43) Pub. Date: Mar. 16, 2017

(54) Zinc Containing Catalysts, Methods For Preparing The Catalysts, And Compositions Containing The Catalysts

(71) Applicant: DOW CORNING CORPORATION, Midland, MI (US)

(72) Inventors: Timothy Dill, Saginaw, MI (US); Avril Surgenor, Waterloo (BE); Ming-Shin Tzou, Midland, MI (US)

(73) Assignee: Dow Corning Corporation, Midland, MI (US)

(21) Appl. No.: 15/116,297

(22) PCT Filed: Apr. 15, 2015
(86) PCT No.: PCT/US15/25874

§ 371 Date: Aug. 3, 2016

Related U.S. Application Data
(60) Provisional application No. 62/001,090, filed on May 21, 2014.

(51) Int. Cl. D21H 19/32; C09D 183/04; B01J 31/22

(52) U.S. Cl. CPC D21H 19/32; B01J 31/22; C09D 183/04

(57) ABSTRACT

A composition is capable of curing via condensation reaction. The composition uses a new condensation reaction catalyst. The new condensation reaction catalyst is used to replace conventional tin catalysts. The composition can react to form a gum, gel, rubber, or resin.

Tin compounds are useful as catalysts for the condensation cure of many polyorganosiloxane compositions, including adhesives, sealants, and low permeability products such as those useful in insulating glass applications, coatings, and silicone elastomer lattices. Organotin compounds for condensation reaction catalysis are those where the oxidation state of the tin is either +4 or +2, i.e., Tin (IV) compounds or Tin (II) compounds. Examples of tin (IV) compounds include stannic salts such as dibutyl tin dilaurate, dimethyl tin dilaurate, di-(n-butyl)tin bis-ketonate, dibutyl tin diacetate, dibutyl tin maleate, dibutyl tin diacetylacetonate, dibutyl tin dimethoxide, carbomethoxyphenyl tin tris-uberate, dibutyl tin dioctanoate, dibutyl tin diformate, isobutyl tin triceroate, dimethyl tin dibutyrate, dimethyl tin di-neodeconoate, dibutyl tin di-neodeconoate, triethyl tin tartrate, dibutyl tin dibenzoate, butyltintri-2-ethylhexanoate, dioctyl tin diacetate, tin octylate, tin oleate, tin butyrate, tin naphthenate, dimethyl tin dichloride, a combination thereof, and/or a partial hydrolysis product thereof. Tin (IV) compounds are known in the art and are commercially available, such as Metatin® 740 and Fascat® 4202 from Acima Specialty Chemicals of Switzerland, Europe, which is a business unit of The Dow Chemical Company. Examples of tin (II) compounds include tin (II) salts of organic carboxylic acids such as tin (II) diacetate, tin (II) dioctanoate, tin (II) diethylhexanoate, tin (II) dilaurate, stannous salts of carboxylic acids such as stannous octoate, stannous oleate, stannous acetate, stannous laurate, stannous stearate, stannous naphthanate, stannous hexanoate, stannous succinate, stannous caprylate, and a combination thereof.

REACH (Registration, Evaluation, Authorization and Restriction of Chemical) is European Union legislation aimed to help protect human health and the environment and to improve capabilities and competitiveness through the chemical industry. Due to this legislation, tin based catalysts, which are used in many condensation reaction curable polyorganosiloxane products such as sealants and coatings, are to be phased out. Therefore, there is an industry need to replace conventional tin catalysts in condensation reaction curable compositions.

### BRIEF SUMMARY OF THE INVENTION

A reaction product of ingredients comprising a Zinc precursor (Zn precursor) and a ligand, and methods for preparation of the reaction product are disclosed. A composition, which is capable of forming a product via condensation reaction, comprises the reaction product.

### DETAILED DESCRIPTION OF THE INVENTION

All amounts, ratios, and percentages are by weight unless otherwise indicated. The amounts of all ingredients in a composition total 100% by weight. The Brief Summary of the Invention and the Abstract are hereby incorporated by reference. The articles ‘a’, ‘an’, and ‘the’ each refer to one or more, unless otherwise indicated by the context of specification. The disclosure of ranges includes the range itself and also anything subsumed therein, as well as endpoints. For example, disclosure of a range of 2.0 to 4.0 includes not only the range of 2.0 to 4.0, but also 2.1, 2.3, 3.4, 3.5, and 4.0 individually, as well as any other number subsumed in the range. Furthermore, disclosure of a range of, for example, 2.0 to 4.0 includes the subsets of, for example, 2.1 to 3.5, 2.3 to 3.4, 2.6 to 3.7, and 3.8 to 4.0, as well as any other subset subsumed in the range. Similarly, the disclosure of Markush groups includes the entire group and also any individual members and subgroups subsumed therein. For example, disclosure of the Markush group a hydrogen atom, an alkyl group, an aryl group, or an aralkyl group includes the member alkyl individually; the subgroup alkyl and aryl; and any other individual member and subgroup subsumed therein.

“Alkyl” means an acyclic, branched or unbranched, saturated monovalent hydrocarbon group. Examples of alkyl groups include Me, Et, Pr, 1-methylethyl, Bu, 1-methylpropyl, 2-methylpropyl, 1,1-dim ethylethyl, 1-methylbutyl, 1-ethylpropyl, pentyl, 2-methylbutyl, 3-methylbutyl, 1,2-dimethylpropyl, 2,2-dimethylpropyl, hexyl, heptyl, 2-ethylhexyl, octyl, nonyl, and decyl; and as well as other branched saturated monovalent hydrocarbon groups with 6 or more carbon atoms. Alkyl groups have at least one carbon atom. Alternatively, alkyl groups may have 1 to 12 carbon atoms, alternatively 1 to 10 carbon atoms, alternatively 1 to 6 carbon atoms, alternatively 1 to 4 carbon atoms, alternatively 1 to 2 carbon atoms, and alternatively 1 carbon atom.

“Aralkyl” and “alkaryl” each refer to an alkyl group having a pendant and/or terminal aryl group or an aryl group having a pendant alkyl group. Exemplary aralkyl groups include benzyl, tolyl, xylyl, phenylethyl, phenyl propyl, and phenyl butyl. Aralkyl groups have at least 7 carbon atoms. Monocyclic aralkyl groups may have 7 to 12 carbon atoms, alternatively 7 to 9 carbon atoms, and alternatively 7 to 8 carbon atoms. Polycyclic aralkyl groups may have 7 to 17 carbon atoms, alternatively 7 to 14 carbon atoms, and alternatively 9 to 10 carbon atoms.

“Alkenyl” means an acyclic, branched, or unbranched unsaturated monovalent hydrocarbon group, where the monovalent hydrocarbon group has a double bond. Alkenyl groups include Vi, allyl, propenyl, and hexenyl. Alkenyl groups have at least 2 carbon atoms. Alternatively, alkenyl groups may have 2 to 12 carbon atoms, alternatively 2 to 10 carbon atoms, alternatively 2 to 6 carbon atoms, alternatively 2 to 4 carbon atoms, and alternatively 2 carbon atoms.

“Alkynyl” means an acyclic, branched, or unbranched unsaturated monovalent hydrocarbon group, where the monovalent hydrocarbon group has a triple bond. Alkynyl groups include ethynyl and propynyl. Alkynyl groups have at least 2 carbon atoms. Alternatively, alkynyl groups may have 2 to 12 carbon atoms, alternatively 2 to 10 carbon atoms, alternatively 2 to 6 carbon atoms, alternatively 2 to 4 carbon atoms, and alternatively 2 carbon atoms.

“Aryl” means a hydrocarbon group derived from an arene by removal of a hydrogen atom from a ring carbon atom. Aryl is exemplified by, but not limited to, Ph and naphthyl. Aryl groups have at least 5 carbon atoms. Monocyclic aryl groups may have 5 to 9 carbon atoms, alternatively 6 to 7 carbon atoms, and alternatively 6 carbon atoms. Polycyclic aryl groups may have 10 to 17 carbon atoms, alternatively 10 to 14 carbon atoms, and alternatively 12 to 14 carbon atoms.

“Carbocycle” and “carbocyclic” refer to a hydrocarbon ring. Carbocycles may be monocyclic or polycyclic, e.g., bicyclic or with more than two rings. Bicyclic carbocycles may be fused, bridged, or spiro polycyclic rings. Carbocycles have at least 3 carbon atoms. Monocyclic carbocycles may have 3 to 9 carbon atoms, alternatively 4 to 7 carbon atoms, and alternatively 5 to 6 carbon atoms. Polycyclic carbocycles may have 7 to 17 carbon atoms, alternatively 7 to 14 carbon atoms, and alternatively 9 to 10 carbon atoms. Carbocycles may be saturated (e.g., cyclopentane or cyclohexane), partially unsaturated (e.g., cyclopentene or cyclohexene), or fully unsaturated (e.g., cyclopentadiene or cycloheptatriene).

“Cycloalkyl” refers to a saturated hydrocarbon group including a carbocycle. Cycloalkyl groups are exemplified by cyclobutyl, cyclopentyl, cyclohexyl, and methylcyclohexyl. Cycloalkyl groups have at least 3 carbon atoms. Monocyclic cycloalkyl groups may have 3 to 9 carbon atoms, alternatively 4 to 7 carbon atoms, and alternatively 5 to 6 carbon atoms. Polycyclic cycloalkyl groups may have 7 to 17 carbon atoms, alternatively 7 to 14 carbon atoms, and alternatively 9 to 10 carbon atoms.

“Halogenated hydrocarbon” means a hydrocarbon where one or more hydrogen atoms bonded to a carbon atom have been formally replaced with a halogen atom. Halogenated hydrocarbon groups include haloalkyl groups, halogenated carbocyclic groups, and haloalkenyl groups. Haloalkyl groups include fluorinated alkyl groups such as trifluoromethyl (CF₃), fluoromethyl, trifluoroethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl; and chlorinated alkyl groups such as chloromethyl and 3-chloropropyl. Halogenated carbocyclic groups include fluorinated cycloalkyl groups such as 2,2-difluorocyclopropyl, 2,3-difluorocyclobutyl, 3,4-difluorocyclohexyl, and 3,4-difluoro-5-methylcycloheptyl; and chlorinated cycloalkyl groups such as 2,2-dichlorocyclopropyl, 2,3-dichlorocyclopentyl. Haloalkenyl groups include allyl chloride.

“Heteroatom” means any of the Group 13-17 elements of the IUPAC Periodic Table of the Elements at http://www.iupac.org/fileadmin/user_upload/news/IUPAC_Periodic_Table-1Jun12.pdf, except carbon. “Heteroatom” include, for example, N, O, P, S, Br, Cl, F, and I.

“Heteroatom containing group” means an organic group comprised of a carbon atom and that also includes at least one heteroatom. Heteroatom containing groups may include, for example, one or more of acyl, amide, amine, carboxyl, cyano, epoxy, hydrocarbonoxy, imino, ketone, ketoxime, mercapto, oxime, and/or thiol. For example, when the heteroatom containing group contains one or more halogen atoms, then the heteroatom containing group may be a halogenated hydrocarbon group as defined above. Alternatively, when the heteroatom is oxygen, then the heteroatom containing group may be a hydrocarbonoxy group such as an alkoxy group or an alkylalkoxy group.

“Inorganic heteroatom containing group” means group comprised of at least 1 heteroatom and at least 1 of hydrogen or a different heteroatoms. Heteroatom containing groups may include, for example, one or more of amine, hydroxy, imino, nitro, oxo, sulfonyl, and/or thiol.

“Heteroalkyl” group means an acyclic, branched or unbranched, saturated monovalent hydrocarbon group that also includes at least one heteroatom. “Heteroalkyl” includes haloalkyl groups and alkyl groups in which at least one carbon atom has been replaced with a heteroatom such as N, O, P, or S, e.g., when the heteroatom is O, the heteroalkyl group may be an alkoxy group.

“Heterocycle” and “heterocyclic” each mean a ring group comprised of carbon atoms and one or more heteroatoms in the ring. The heteroatom in the heterocycle may be N, O, P, S, or a combination thereof. Heterocycles may be monocyclic or alternatively may be fused, bridged, or spiro polycyclic rings. Monocyclic heterocycles may have 3 to 9 member atoms in the ring, alternatively 4 to 7 member atoms, and alternatively 5 to 6 member atoms. Polycyclic heterocycles may have 7 to 17 member atoms, alternatively 7 to 14 member atoms, and alternatively 9 to 10 member atoms. Heterocycles may be saturated or partially unsaturated.

“Heteroaromatic” means a fully unsaturated ring containing group comprised of carbon atoms and one or more heteroatoms in the ring. Monocyclic heteroaromatic groups may have 5 to 9 member atoms, alternatively 6 to 7 member atoms, and alternatively 5 to 6 member atoms. Polycyclic heteroaromatic groups may have 10 to 17 member atoms, alternatively 10 to 14 member atoms, and alternatively 12 to 14 member atoms. Heteroaromatic includes heteroaryl groups such as pyridyl. Heteroaromatic includes heteroaralkyl, i.e., an alkyl group having a pendant and/or terminal heteroaryl group or a heteroaryl group having a pendant alkyl group. Exemplary heteroaralkyl groups include methylpyridyl and dimethylpyridyl.

“Free of” means that the composition contains a non-detectable amount of the ingredient, or the composition contains an amount of the ingredient insufficient to change the cure time measured according to the method in Example 2, as compared to the same composition with the ingredient omitted. For example, the composition described herein may be free of tin catalysts. “Free of tin catalysts” means that the composition contains a non-detectable amount of a tin catalyst capable of catalyzing a condensation reaction with the —OH and —H moieties of the ingredients in the composition, or the composition contains an amount of a tin catalyst insufficient to change the cure time measured according to the method in Example 2, as compared to the same composition with the tin catalyst omitted. The composition may be free of titanium catalysts. “Free of titanium catalysts” means that the composition contains a non-detectable amount of a titanium catalyst capable of catalyzing a condensation reaction with the —OH and —H moieties of the ingredients in the composition, or the composition contains an amount of a titanium catalyst insufficient to change the cure time measured according to the method in Example 2, as compared to the same composition with the titanium catalyst omitted. Alternatively, the composition described herein may be free of metal condensation reaction catalysts (i.e., other than ingredient (A) described herein). “Free of metal condensation reaction catalysts” means that the composition contains a non-detectable amount of a compound of a Group 4, 13, 14, or 15 metal of the IUPAC periodic table dated 1 May 2013 (available at http://www.iupac.org/fileadmin/user_upload/news/IUPAC_Periodic_Table-1May13.pdf), which is capable of catalyzing a condensation reaction, such as compounds of Al, Bi, Sn, Ti, and/or Zr; or an amount of such a metal condensation reaction catalyst insufficient to change the cure time measured according to the method in Example 2 as compared to the same composition with the metal condensation reaction catalyst omitted. For purposes of this definition ‘non-detectable amount’ may be measured, for example, according to the method of ASTM D7151-05 Standard Test Method for Determination of Elements in Insulating Oils by Inductively Coupled Plasma Atomic Emission Spectrometry (ICP-AES).

“Non-functional” means that the ingredient, e.g., a polyorganosiloxane, does not have hydrolyzable groups that participate in a condensation reaction.

Abbreviations used herein are defined as follows. The abbreviation “cP” means centiPoise. “DP” means the degree of polymerization of a polymer. “FTIR” means Fourier transform infrared spectroscopy. “GPC” means gel permeation chromatography. “Mn” means number average molecular weight. Mn may be measured using GPC. “Mw” means weight average molecular weight. “NMR” means nuclear magnetic resonance. “Me” means methyl. “Et” means ethyl. “Ph” means phenyl. “Pr” means propyl and includes various structures such as iPr and nPr. “iPr” means isopropyl. “nPr” means normal propyl. “Bu” means butyl and includes various structures including nBu, sec-butyl, tBu, and iBu. “iBu” means isobutyl. “nBu” means normal butyl. “tBu” means tert-butyl.

In one embodiment, a composition comprises:

(A) a catalytically effective amount of the reaction product of the Zn precursor and the ligand, described above, and
(B1) a hydroxy-functional compound having an average, per molecule, of one or more hydroxy (—OH) moieties, and
(B2) a Si—R⁵⁰ functional compound having an average, per molecule, of one or more Si—⁵⁰ moieties, where ingredient (A) is capable of catalyzing a condensation reaction of the hydroxy moiety on ingredient (B1) and the Si—R⁵⁰ moiety on ingredient (B2). The condensation reaction of the —OH and Si—R⁵⁰ moieties on ingredients (B1) and (B2) prepares a reaction product.

The composition may optionally further comprise one or more additional ingredients. The one or more additional ingredients are distinct from ingredients (A), (B1), and (B2). Suitable additional ingredients are exemplified by (C) a crosslinker, (D) a drying agent; (E) an extender, a plasticizer, or a combination thereof; (F) a filler; (G) a filler treating agent; (H) a biocide; (J) a flame retardant; (K) a surface modifier; (L) a chain lengthener; (M) an endblocker; (N) a nonreactive binder; (O) an anti-aging additive; (P) a water release agent; (Q) a pigment; (R) a rheological additive; (S) a vehicle (such as a solvent and/or a diluent); (T) a tackifying agent; (U) a corrosion inhibitor; and a combination thereof.

Ingredient (A) comprises a catalytically effective amount of the Zn containing condensation reaction catalyst. The Zn containing condensation reaction catalyst comprises a reaction product of a Zn precursor and a ligand. Without wishing to be bound by theory, it is thought that this reaction product comprises a Zn-ligand complex. The Zn precursor is distinct from a reaction product of the Zn precursor and the ligand. The Zn precursor may be a compound of Zn. The Zn precursor is a compound of Zn having general formula (i): Zn-Aₐ, where subscript a is 1 to maximum valence of zinc, and each A is independently a displaceable substituent. Each A may be, for example, a monovalent organic group or a monovalent inorganic group, and subscript a has a value ranging from 1 to 2. Alternatively, a=2. Examples of displaceable substituents for A include monovalent hydrocarbon groups, amino groups, silylamide groups, carboxylic ester groups, and hydrocarbonoxy groups. Displaceable substituent means that the group selected for one or more instances of A may be reacted off or otherwise displaced by the ligand.

Examples of monovalent hydrocarbon groups for A include, but are not limited to, alkyl such as methyl, ethyl, propyl, butyl, pentyl, hexyl, heptyl, ethylhexyl, octyl, decyl, dodecyl, undecyl, and octadecyl; alkenyl such as vinyl, allyl, propenyl, and hexenyl; carbocyclic groups exemplified by saturated carbocyclic groups, e.g., cycloalkyl such as cyclopentyl and cyclohexyl, or unsaturated carbocyclic groups such as cyclopentadienyl or cyclooctadienyl; aryl such as phenyl, tolyl, xylyl, mesityl, and naphthyl; and aralkyl such as benzyl or 2-phenylethyl.

Examples of amino groups for A have formula —NA′₂, where each A′ is independently a hydrogen atom or a monovalent hydrocarbon group. Exemplary monovalent hydrocarbon groups for A′ include, but are not limited to, alkyl such as methyl, ethyl, propyl, butyl, pentyl, hexyl, heptyl, ethylhexyl, octyl, decyl, dodecyl, undecyl, and octadecyl; alkenyl such as vinyl, allyl, propenyl, and hexenyl; carbocyclic groups exemplified by saturated carbocyclic groups, e.g., cycloalkyl such as cyclopentyl and cyclohexyl, or unsaturated carbocyclic groups such as cyclopentadienyl or cyclooctadienyl; aryl such as phenyl, tolyl, xylyl, mesityl, and naphthyl; and aralkyl such as benzyl or 2-phenylethyl. Alternatively, each A′ may be a hydrogen atom or an alkyl group of 1 to 4 carbon atoms, such as methyl or ethyl.

Alternatively, for A in general formula (i) the silylamide group may have general formula —N(SiA′″₃)₂, where each A′″ is independently a monovalent hydrocarbon group. Examples of monovalent hydrocarbon groups for A′″ include, but are not limited to, alkyl such as methyl, ethyl, propyl, butyl, pentyl, hexyl, heptyl, ethylhexyl, octyl, decyl, dodecyl, undecyl, and octadecyl; alkenyl such as vinyl, allyl, propenyl, and hexenyl; cycloalkyl such as cyclopentyl and cyclohexyl; aryl such as phenyl, tolyl, xylyl, and naphthyl; aralkyl such as benzyl or 2-phenylethyl. Alternatively, each A′″ may be an alkyl group, such as methyl, ethyl, n-propyl, iso-propyl, n-butyl, iso-butyl, or t-butyl. Alternatively, each A′″ may be an alkyl group, and alternatively each A′″ may be methyl, ethyl, propyl such as iso-propyl or n-propyl, or butyl.

Alternatively, each A in general formula (i) may be a carboxylic ester group. Examples of suitable carboxylic ester groups for A include, but are not limited to ethylhexanoate (such as 2-ethylhexanoate), neodecanoate, octanoate, and stearate.

Examples of monovalent hydrocarbonoxy groups for A may have formula —O-A″, where A″ is a monovalent hydrocarbon group. Examples of monovalent hydrocarbon groups for A″ include, but are not limited to, alkyl such as methyl, ethyl, propyl, butyl, pentyl, hexyl, heptyl, ethylhexyl, octyl, decyl, dodecyl, undecyl, and octadecyl; alkenyl such as vinyl, allyl, propenyl, and hexenyl; cycloalkyl such as cyclopentyl and cyclohexyl; aryl such as phenyl, tolyl, xylyl, and naphthyl; aralkyl such as benzyl or 2-phenylethyl. Alternatively, each A″ may be an alkyl group, such as methyl, ethyl, n-propyl, iso-propyl, n-butyl, iso-butyl, or t-butyl. Alternatively, each A″ may be an alkyl group, and alternatively each A″ may be ethyl, propyl such as iso-propyl or n-propyl, or butyl.

Alternatively, each A may be an alkyl group, such as methyl, ethyl, n-propyl, iso-propyl, n-butyl, iso-butyl, or t-butyl. Alternatively, each A may be selected from the group consisting of ethyl, benzyl, mesityl, phenyl, —NEt₂, cyclooctadiene, ethoxide, iso-propoxide, butoxide, 2-ethylhexanoate, neodecanoate, octanoate, and stearate. Alternatively, each A may be independently selected from a silyl amide group, an alkyl group, and a carboxylic ester group. Alternatively, each A may be a silyl amide group. Alternatively, each A may be a carboxylic ester group.

Organic compounds of Zn suitable for use as precursors are commercially available. For example, dialkyl zinc compounds such as Zn-Et₂ and diaryl zinc compounds such as compounds of zinc such as Zn-Ph₂ are commercially available from Sigma-Aldrich of St. Louis, Mo., U.S.A. (Aldrich). Zinc(II) bis(trialkylsilyl)amides such as zinc bis(bis(trimethylsilyl)amide) is also commercially available from Aldrich. Diesters of zinc, such as Zn(octanoate)₂, are commercially available from City Chemicals LLC of West Haven, Conn., U.S.A. Zinc 2-ethylhexanoate is commercially available from Strem Chemicals, Inc. of Newburyport, Mass., U.S.A.

The ligand is an organic compound that coordinates with Zn. The organic compound includes neutral and conjugate base forms. Without wishing to be bound by theory, it is thought that the ligand displaces one or more instances of displaceable substituent A in the Zn precursor of general formula (i) above to form the reaction product of ingredient (A).

In one embodiment, the ligand is an amino-functional organic compound comprising 2 or more amino-functional moieties, alternatively 2 to 3 amino-functional moieties, of general formula (ii):

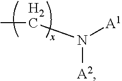

where subscript x is 1 or 2, and A¹ and A² are each independently selected from monovalent hydrocarbon groups and monovalent halogenated hydrocarbon groups as defined herein. The monovalent hydrocarbon groups are exemplified by alkyl groups as defined herein. Alternatively, x may be 1. Alternatively x may be 2. Alternatively, A¹ and A² may each be alkyl groups of 1 to 6 carbon atoms; alternatively 1 to 4 carbon atoms; and alternatively 1 to 2 carbon atoms.

The ligand may be a triamino-functional compound. For example, the ligand may have formula (iii):

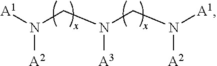

where x, A¹ and A² are as described above and A³ is selected from a hydrogen atom and an alkyl group of 1 to 6 carbon atoms; alternatively 1 to 4 carbon atoms; and alternatively 1 to 2 carbon atoms. Examples of ligands of general formula (iii) include N,N,N′,N″,N″-pentamethyldiethylenetriamine or N,N,N′,N′-tetraethyldiethylenetriamine.

Alternatively, the ligand may have general formula (iv):

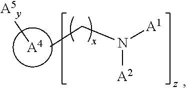

where x, A¹, and A² are as described above and group A⁴ is a carbocyclic group having at least 3 carbon atoms covalently bonded in a ring, subscript y is at least 1, subscript z is at least 2, and a quantity (y+z) represents valence of A⁴, where the carbocyclic group has a moiety of formula A⁵ and the moieties of general formula (ii)

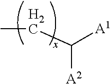

covalently bonded to carbon atoms in the ring; and each A⁵ is independently a hydrogen atom or a hydroxy group. A⁴ may be, for example, a cycloalkyl group or an aryl group, as defined herein. Alternatively, A⁴ may be an aryl group such as phenyl. Each A⁵ is independently a hydrogen atom or a hydroxy group. Alternatively, one A⁵ is a hydroxy group and each remaining instance of A⁵ is a hydrogen atom. Alternatively, subscript z is 2 to 3; alternatively subscript z is 3. Examples of ligands of general formula (iv): include 2,4,6-tris(dimethylaminomethyl)phenol.

Examples of suitable ligands for use in preparing ingredient (A) include each ligand having a neutral form shown below in Table 1.

| Ligand | Structure |
|---|---|
| N,N,N′,N″,N″- Pentamethyldiethylenetriamine | 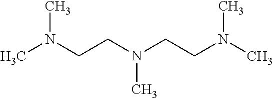 |
| N,N,N′,N′- Tetraethyldiethylenetriamine | 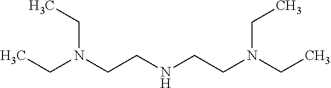 |
| 2,4,6- Tris(dimethylaminomethyl)phenol | 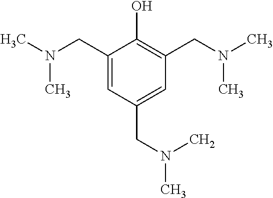 |

Various ligands in Table 1 are commercially available. For example, ligands 2,4,6-tris(dimethylaminomethyl)phenol, N,N,N′,N″,N″-pentamethyldiethylenetriamine, and N,N,N′,N′-tetraethyldiethylenetriamine are each commercially available from Aldrich.

In an alternative embodiment, the ligand is an amino-functional organic compound comprising one or more amino-functional moieties of general formula (ii), described above. Alternatively, the ligand may have 1 amino-functional moiety of general formula (ii) per molecule. In this embodiment, the ligand may have general formula (v):

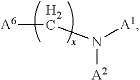

where subscript x, A¹, and A² are as described above. Each A⁶ is independently a monovalent organic group. A⁶ may be a monovalent heteroatom containing group or a monovalent hydrocarbon group. Monovalent heteroatom containing groups are exemplified by a monovalent halogenated hydrocarbon group, an amino group of formula:

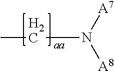

where A⁷ is hydrogen or A¹, A⁸ is hydrogen or A², and subscript aa is 0 to 2; or a hydroxyl functional group of formula

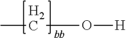

where subscript bb is 0 to 2; or an amino and hydroxyl functional group of formula

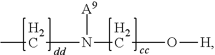

where subscript cc is 1 or 2, subscript dd is 1 or 2, and A⁹ is hydrogen or alkyl. Alternatively, the monovalent hydrocarbon groups are exemplified by alkyl groups as defined herein. Alternatively, x may be 1. Alternatively x may be 2. Alternatively, A¹ and A² may each be alkyl groups of 1 to 6 carbon atoms; alternatively 1 to 4 carbon atoms; and alternatively 1 to 2 carbon atoms. Examples of ligands of general formula (v) include ligands L6, L7, L8, L9, L10, and L11 in Table 1-B, below.

Alternatively, A⁶ may be the amino group of formula

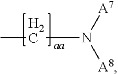

and subscript aa may be 0 or 1, A⁷ may be hydrogen or alkyl, and A⁸ may be hydrogen or alkyl. Alternatively, A⁷ may be hydrogen and A⁸ may be alkyl. Alternatively, A⁷ and A⁸ may each be hydrogen. Alternatively, A⁷ and A⁸ may each be alkyl, such as methyl or ethyl. Examples of ligands with this formula include ligands L8, L9, and L10 in Table 1-B, below.

Alternatively, A⁶ may be the hydroxyl functional group of formula

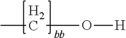

and subscript bb may be 0 or 1. Examples of ligands with this formula include ligands L6 and L7 in Table 1-B, below.

Alternatively, A⁶ may be the amino and hydroxyl functional group of formula

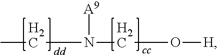

where subscript cc is 1 or 2, subscript dd is 1 or 2, and A⁹ is hydrogen or alkyl. Alternatively, A⁹ may be alkyl such as methyl. Examples of ligands with this formula include ligand L11 in Table 1-B, below.

Alternatively, the ligand may have general formula (vi):

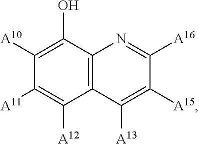

where A¹⁰, A¹¹, A¹², A¹³, A¹⁴, A¹⁵, and A¹⁶ are each independently selected from hydrogen and an alkyl group, such as methyl, ethyl, propyl or butyl. Alternatively, A¹⁰, A¹¹, A¹², A¹³, A¹⁴, A¹⁵, and A¹⁶ are each hydrogen or methyl. Alternatively, A¹⁰, A¹¹, A¹², A¹³, A¹⁴, A¹⁵, and A¹⁶ are each hydrogen. Examples of ligands of general formula (vi) include ligand L12 in Table 1-B.

Examples of suitable ligands for use in preparing ingredient (A) include each ligand having a neutral form shown below in Table 1-B.

TABLE 1-B

| Ligand | Structure |
|---|---|
| L6 | 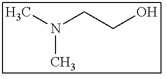 |
| L7 | 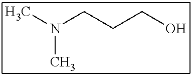 |
| L8 | 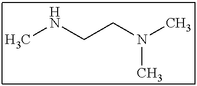 |
| L9 | 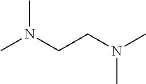 |
| L10 | 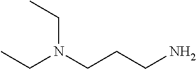 |
| L11 | 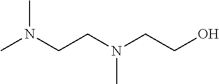 |
| L12 | 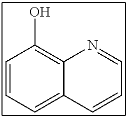 [SMILES: Oc1cccc2cccnc12] |

Ingredient (A) may be prepared by a method comprising reacting the ligand and the Zn precursor, described above, thereby forming a catalytically active reaction product. Without wishing to be bound by theory, it is thought that the catalytically active reaction product comprises a Zn-ligand complex. The method may optionally further comprise a step of dissolving either the Zn precursor, or the ligand, or both, in a solvent before combining the Zn precursor and the ligand. Suitable solvents are exemplified by those described below for ingredient (S). Alternatively, the ligand may be dissolved in a solvent in a container, and the solvent may thereafter be removed before adding the Zn precursor to the container with the ligand. The amounts of ligand and Zn precursor are selected such that the mole ratio of ligand to Zn precursor (Ligand:Metal Ratio) may range from 10:1 to 1:1, alternatively 1:1 to 3:1, and alternatively 1:1 to 2:1. Combining the Zn precursor and the ligand may be performed by any convenient means, such as mixing them together in or shaking the container.

Reacting the Zn precursor and ligand may be performed by any convenient means such as allowing the Zn precursor and ligand prepared as described above to react at room temperature (RT) of 25° C. for a period of time, or by heating. Heating may be performed by any convenient means, such as via a heating mantle, heating coil, or placing the container in an oven. The reaction temperature depends on various factors including the reactivities of the specific Zn precursor and ligand selected and the Ligand:Metal Ratio, however, temperature may range from 25° C. to 200° C., alternatively 25° C. to 75° C. Reaction time depends on various factors including the reaction temperature selected, however, reaction time may range from 1 minute to 48 hours, alternatively 45 minutes (min) to 60 min. The ligand and Zn precursor may be combined and heated sequentially. Alternatively, the ligand and Zn precursor may be combined and heated concurrently.

The method of preparing the catalytically active reaction product of ingredient (A) may optionally further comprise adding a solvent after the reaction. Suitable solvents are exemplified by those described below for ingredient (S). Alternatively, the method may optionally further comprise removing a reaction by-product and/or the solvent, if the solvent is present (e.g., used to facilitate combination of the Zn precursor and the ligand before or during heating). By-products include, for example, H-A (where A is as defined above in general formula (i)) or any species resulting from reacting an organic group off the Zn precursor when the ligand reacts with the Zn precursor. By-products may be removed by any convenient means, such as stripping or distillation, with heating or under vacuum, or a combination thereof. The resulting isolated Zn-ligand complex may be used as the catalytically active reaction product of ingredient (A).

Alternatively, the reaction by-products are not removed before using the catalytically active reaction product as ingredient (A). For example, the ligand and Zn precursor may be reacted as described above, with or without solvent removal, and the resulting catalytically active reaction product (comprising the Zn-ligand complex and the reaction by-product and optionally a solvent or diluent) may be used as ingredient (A). Without wishing to be bound by theory, it is thought that a by-product may act as a condensation reaction catalyst in addition to the Zn-ligand complex, or as a co-catalyst or an activator for the Zn-ligand complex. Therefore, the reaction product may catalyze a condensation reaction.

The composition may contain one single catalyst. Alternatively, the composition may comprise two or more catalysts described above as ingredient (A), where the two or more catalysts differ in at least one property such as selection of ligand, selection of precursor, Ligand:Metal Ratio, and definitions for group A in general formula (i). The composition may be free of tin catalysts, alternatively the composition may be free of titanium catalysts, and alternatively the composition may be both free of tin catalysts and free of titanium catalysts. Alternatively, the composition may be free of any Zn compound that would catalyze the condensation reaction of the hydroxy groups on ingredient (B1) other than ingredient (A). Alternatively, the composition may be free of metal condensation reaction catalysts other than ingredient (A). Alternatively, the composition may be free of any ingredient that would catalyze the condensation reaction of the hydroxy groups on ingredient (B1) other than ingredient (A).

Ingredient (A) is present in the composition in a catalytically effective amount. The exact amount depends on various factors including reactivity of ingredient (A), the type and amount of ingredient (B1), and the type and amount of any additional ingredient, if present. However, the amount of ingredient (A) in the composition may range from 1 part per million (ppm) to 10%, alternatively 10 ppm to 5%, alternatively 0.1% to 2%, and alternatively 1 ppm to 1%, based on total weight of all ingredients in the composition.

Ingredient (B1) is a hydroxy-functional compound. Ingredient (B1) has one or more —OH moieties per molecule, alternatively two or more —OH moieties. The hydroxy-functional compound may contain additional functional groups (i.e., one or more functional groups other than OH), such as carboxyl, amino, urea, carbamate, amide, or epoxy. The hydroxy-functional compound may be a diol. Alternatively, the hydroxy-functional compound may be a polyol having an average of more than one OH group per molecule, alternatively 2 or more OH groups per molecule, and alternatively 10 to 1000 OH groups per molecule. Ingredient (B1) may be selected from a polyorganosiloxane such as a polydiorganosiloxane, an organic polymer, or a silicone-organic copolymer (having the one or more hydroxy groups of formula OH covalently bonded to a Si atom and/or carbon atom in the polymer backbone and/or terminus). Alternatively (B1) may be a monohydric alcohol, such as methanol, ethanol, isopropanol, butanol, or n-propanol. Alternatively, ingredient (B1) may be a polyorganosiloxane, or an organic polymer. Alternatively ingredient (B1) may be a polyorganosiloxane. The hydroxy group in ingredient (B1) may be located at terminal, pendant, or both terminal and pendant positions in the polymer. Ingredient (B1) may comprise a linear, branched, cyclic, or resinous structure. Alternatively, ingredient (B1) may comprise a linear, branched or cyclic structure. Alternatively, ingredient (B1) may comprise a linear or branched structure. Alternatively, ingredient (B1) may comprise a linear structure. Alternatively, ingredient (B1) may comprise a linear structure and a resinous structure. Ingredient (B1) may comprise a homopolymer or a copolymer or a combination thereof.

Ingredient (B1) may have the hydroxy groups contained in groups of the formula (ii):

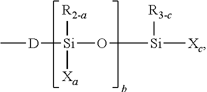

where each D independently represents an oxygen atom, a divalent organic group, a divalent silicone organic group, or a combination of a divalent hydrocarbon group (what does it mean here about divalent hydrocarbon?) and a divalent siloxane group; each X independently represents a hydroxy group of formula OH; each R independently represents a monovalent hydrocarbon group; subscript c represents 0, 1, 2, or 3; subscript a represents 0, 1, or 2; and subscript b has a value of 0 or greater, with the proviso that the sum of (a+c) is at least 1, such that, on average, at least one X is present in the formula. Alternatively, subscript b may have a value ranging from 0 to 18 (This can be larger than 18. In paper coating, a disilanol gum may be used in formulation).

Alternatively, each D may be independently selected from an oxygen atom and a divalent hydrocarbon group. Alternatively, each D may be an oxygen atom. Alternatively, each D may be a divalent hydrocarbon group exemplified by an alkylene group such as ethylene, propylene, butylene, or hexylene; an arylene group such as phenylene, or an alkylarylene group such as:

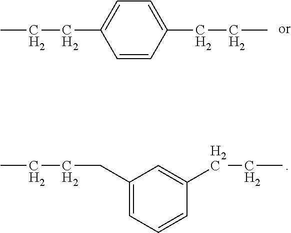

Alternatively, an instance of D may be an oxygen atom while a different instance of D is a divalent hydrocarbon group. (we can have OH group on the carbon of the divalent hydrocarbon group.) (we can even have OH groups at the terminal of a linear or branch hydrocarbon)

Alternatively, each R in the formula above may be independently selected from alkyl groups of 1 to 20 carbon atoms, aryl groups of 6 to 20 carbon atoms, and aralkyl groups of 7 to 20 carbon atoms.

Alternatively, subscript b may be 0.

Ingredient (B1) may comprise the groups described by formula (ii) above in an amount of the base polymer ranging from 0.2 mol % to 10 mol %, alternatively 0.5 mol % to 5 mol %, alternatively 0.5 mol % to 2.0 mol %, alternatively 0.5 mol % to 1.5 mol %, and alternatively 0.6 mol % to 1.2 mol %.

Ingredient (B1) may be a polyorganosiloxane with a linear structure, i.e., a polydiorganosiloxane. When ingredient (B1) is a polydiorganosiloxane, ingredient (B1) may comprise a hydroxy-endblocked polydiorganosiloxane, an hydroxysilylhydrocarbylene-endblocked polydiorganosiloxane, or a combination thereof.

Ingredient (B1) may comprise a polydiorganosiloxane of formula (I):

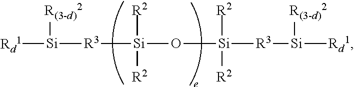

where each R¹ is independently a hydroxy group, each R² is independently a monovalent organic group, each R³ is independently an oxygen atom or a divalent hydrocarbon group, each subscript d is independently 1, 2, or 3, and subscript e is an integer having a value sufficient to provide the polydiorganosiloxane with a viscosity of at least 100 mPa·s at 25° C. and/or a DP of at least 87. DP may be measured by GPC using polystyrene standards calibration. Alternatively, subscript e may have a value ranging from 1 to 200,000.

Suitable organic groups for R² include, but are not limited to, monovalent organic groups such as hydrocarbon groups and halogenated hydrocarbon groups. Examples of monovalent hydrocarbon groups for R² include, but are not limited to, alkyl such as methyl, ethyl, propyl, pentyl, octyl, decyl, dodecyl, undecyl, and octadecyl; cycloalkyl such as cyclopentyl and cyclohexyl; aryl such as phenyl, tolyl, xylyl, and benzyl; and aralkyl such as 2-phenylethyl. Examples of monovalent halogenated hydrocarbon groups for R² include, but are not limited to, chlorinated alkyl groups such as chloromethyl and chloropropyl groups; fluorinated alkyl groups such as fluoromethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl; chlorinated cycloalkyl groups such as 2,2-dichlorocyclopropyl, 2,3-dichlorocyclopentyl; and fluorinated cycloalkyl groups such as 2,2-difluorocyclopropyl, 2,3-difluorocyclobutyl, 3,4-difluorocyclohexyl, and 3,4-difluoro-5-methylcycloheptyl. Examples of other monovalent organic groups for R² include, but are not limited to, hydrocarbon groups substituted with oxygen atoms such as glycidoxyalkyl, and hydrocarbon groups substituted with nitrogen atoms such as aminoalkyl and cyano-functional groups such as cyanoethyl and cyanopropyl. Alternatively, each R² may be an alkyl group such as methyl.

Ingredient (B1) may comprise an α,ω-difunctional-polydiorganosiloxane when, in formula (I) above, each subscript d is 1 and each R³ is an oxygen atom. For example, ingredient (B1) may have formula (II): R¹R²₂SiO—(R²₂SiO)_{e′}—SiR²₂R¹, where R¹ and R² are as described above and subscript e′ is an integer having a value sufficient to give the polydiorganosiloxane of formula (II) the viscosity described above. Alternatively, subscript e′ may have a value ranging from 1 to 200,000, alternatively 50 to 1,000, and alternatively 200 to 700.

Alternatively, in formula (II) described above, each R² may be an alkyl group such as methyl, and subscript e′ may have a value such that the hydroxy functional polydiorganosiloxane has a viscosity of at least 100 mPa·s at 25° C. Alternatively, subscript e′ may have a value ranging from 50 to 700. Exemplary hydroxy-endblocked polydiorganosiloxanes are hydroxy-endblocked polydimethylsiloxanes. Hydroxy-endblocked polydiorganosiloxanes suitable for use as ingredient (B1) may be prepared by methods known in the art, such as hydrolysis and condensation of the corresponding organohalosilanes or equilibration of cyclic polydiorganosiloxanes.

Alternatively, ingredient (B1) may comprise a hydroxy functional organic polymer. Alternatively, the organic polymer may be a polymer in which at least half the atoms in the polymer backbone are carbon atoms with terminal hydroxy groups. The organic polymer can, for example, be selected from hydrocarbon polymers, polyethers, acrylate polymers, polyols, polyurethanes and polyureas.

Ingredient (B1) may be an organic hydroxy-functional compound. The organic hydroxy-functional compound may be a monohydric alcohol such as methanol, ethanol, isopropanol, butanol, or n-propanol; a polyether polyol, such as dipropylene glycol or a poly(tetraalkyene ether) glycol such as glycerol propoxylate; a polyester polyol; a polyester-amide polyol; a polyacetal polyol; a polycarbonate polyol; a polycaprolactone polyol; a polybutadiene polyol; a poly(propylene oxide)polyol; a poly(propylene oxide/ethylene oxide) copolymer; a polyether polyol; and a polysulfide polyol. Exemplary hydroxy-functional compounds with two OH groups per molecule include ethylene glycol, diethylene glycol, triethylene glycol, tetraethylene glycol, propylene glycol (1,2-propylene glycol and/or 1,3-propylene glycol), 1,4-butylene glycol, 2,3-butylene glycol, dipropylene glycol, tripropylene glycol, 1,3-propanediol, 1,3-butanediol, 1,4-butanediol, neopentyl glycol, 1,6-hexanediol, 1,8-octanediol, neopentyl glycol, 1,4-cyclohexanedimethanol, 2-methyl-1,3-propanediol, and a combination thereof. Exemplary hydroxy-functional compounds with three OH groups per molecule include glycerol, trimethylolpropane, 1,2,4-butanetriol, 1,2,6-hexanetriol, glycerol propoxylate, triglycerol, and a combination thereof.

Other organic polyhydroxy compounds that may be used include, pentaerythritol, mannitol, sorbitol, poly(ethyleneoxy) glycols generally, poly(propyleneoxy) glycols generally, dibutylene glycol, poly(butyleneoxy) glycols, and polycaprolactone. Other polyhydroxy materials of higher molecular weight which may be used are the polymerization products of epoxides such as ethylene oxide, propylene oxide, butylene oxide, styrene oxide, and epichlorohydrin. A particularly common high molecular weight polyol is polytetramethylene glycol. A commercial polyol is Desmophen® R-221-75 polyol (equivalent weight 515 g/mol carbon-bonded hydroxy) (Bayer, Pittsburgh, Pa.)

The organic hydroxy-functional compounds have on average at least one carbon-bonded hydroxy group per molecule. Alternatively, the equivalent weight of carbon-bonded hydroxy groups on the organic hydroxy-functional compound may be from 80 to 800, alternatively 100 to 600.

Alternatively, ingredient (B1) may be elastomeric, i.e., have a glass transition temperature (Tg) less than 0° C. When ingredient (B1) is elastomeric, ingredient (B1) may be distinguished, based on the Tg, from semi-crystalline and amorphous polyolefins (e.g., alpha-olefins), commonly referred to as thermoplastic polymers.

Ingredient (B1) may comprise a silylated poly(alpha-olefin), a silylated copolymer of an iso-mono-olefin and a vinyl aromatic monomer, a silylated copolymer of a diene and a vinyl aromatic monomer, a silylated copolymer of an olefin and a diene (e.g., a silylated butyl rubber prepared from polyisobutylene and isoprene, which may optionally be halogenated), or a combination thereof (silylated copolymers), a silylated homopolymer of the iso-mono-olefin, a silylated homopolymer of the vinyl aromatic monomer, a silylated homopolymer of the diene (e.g., silylated polybutadiene or silylated hydrogenated polybutadiene), or a combination thereof (silylated homopolymers) or a combination silylated copolymers and silylated homopolymers. For purposes of this application, silylated copolymers and silylated homopolymers are referred to collectively as ‘silylated polymers’. The silylated polymer may optionally contain one or more halogen groups, particularly bromine groups, covalently bonded to an atom of the silylated polymer.

Examples of suitable mono-iso-olefins include, but are not limited to, isoalkylenes such as isobutylene, isopentylene, isohexylene, and isoheptylene; alternatively isobutylene. Examples of suitable vinyl aromatic monomers include but are not limited to alkylstyrenes such as alpha-methylstyrene, t-butylstyrene, and para-methylstyrene;

alternatively para-methylstyrene. Examples of suitable alkyl groups include methyl, ethyl, n-propyl, isopropyl, n-butyl, isobutyl, and t-butyl; alternatively methyl. Examples of suitable alkenyl groups include, vinyl, allyl, propenyl, butenyl, and hexenyl; alternatively vinyl. The silylated organic polymer may have Mn ranging from 20,000 to 500,000, alternatively 50,000-200,000, alternatively 20,000 to 100,000, alternatively 25,000 to 50,000, and alternatively 28,000 to 35,000; where values of Mn are expressed in grams per mole (g/mol) and were measured by Triple Detection Size Exclusion Chromatography and calculated on the basis of polystyrene molecular weight standards.

Examples of suitable silylated poly(alpha-olefins) are known in the art and are commercially available. Examples include the condensation reaction curable silylated polymers marketed as VESTOPLAST®, which are commercially available from Degussa AG Coatings & Colorants of Marl, Germany, Europe.

Briefly stated, a method for preparing the silylated copolymers involves contacting i) an olefin copolymer having at least 50 mole % of repeat units comprising residuals of an iso-mono-olefin having 4 to 7 carbon atoms and at most 50 mole % of repeat units comprising residuals of a vinyl aromatic monomer; ii) a silane having at least two hydrolyzable groups and at least one olefinically unsaturated hydrocarbon or hydrocarbonoxy group; and iii) a free radical generating agent.

Alternatively, silylated copolymers may be prepared by a method comprising conversion of commercially available hydroxylated polybutadienes (such as those commercially available from Cray Valley SA of Paris, France, under trade names Poly BD and Krasol) by known methods (e.g., reaction with isocyanate functional alkoxysilane, reaction with allyl chloride in presence of Na followed by hydrosilylation).

Alternatively, examples of suitable silyl modified hydrocarbon polymers include silyl modified polyisobutylene, which is available commercially in the form of telechelic polymers. Silyl modified polyisobutylene can, for example, contain curable silyl groups derived from a silyl-substituted alkyl acrylate or methacrylate monomer such as a dialkoxyalkylsilylpropyl methacrylate or trialkoxysilylpropyl methacrylate, which can be reacted with a polyisobutylene prepared by living anionic polymerisation, atom transfer radical polymerization or chain transfer polymerization.

Alternatively, ingredient (B1) may comprise a polyether. One type of polyether is a polyoxyalkylene polymer comprising recurring oxyalkylene units of the formula (—CₜH₂ₜ—O—) where subscript t is an integer with a value ranging from 2 to 4. Polyoxyalkylene polymers typically have terminal hydroxy groups. Alternatively, polymerization may occur via a hydrosilylation type process. Polyoxyalkylenes comprising mostly oxypropylene units may have properties suitable for many sealant uses.

The organic polymer can alternatively be an acrylate polymer, that is an addition polymer of acrylate and/or methacrylate ester monomers, which may comprise at least 50 mole % of the monomer repeat units in the acrylate polymer. Examples of suitable acrylate ester monomers are n-butyl, isobutyl, n-propyl, ethyl, methyl, n-hexyl, n-octyl and 2-ethylhexyl acrylates. Examples of suitable methacrylate ester monomers are n-butyl, isobutyl, methyl, n-hexyl, n-octyl, 2-ethylhexyl and lauryl methacrylates. For some applications, the acrylate polymer may have a Tg below ambient temperature; and acrylate polymers may form lower Tg polymers than methacrylate polymers. An exemplary acrylate polymer is polybutyl acrylate. The acrylate polymer may contain lesser amounts of other monomers such as styrene, acrylonitrile or acrylamide. The acrylate polymer can be prepared by various methods such as conventional radical polymerization, or living radical polymerization such as atom transfer radical polymerization, reversible addition-fragmentation chain transfer polymerization, or anionic polymerization including living anionic polymerization. The curable silyl groups can, for example, be derived from a silyl-substituted alkyl acrylate or methacrylate monomer. Hydrolysable silyl groups such as dialkoxyalkylsilyl or trialkoxysilyl groups can, for example, be derived from a dialkoxyalkylsilylpropyl methacrylate or trialkoxysilylpropyl methacrylate. When the acrylate polymer has been prepared by a polymerization process which forms reactive terminal groups, such as atom transfer radical polymerization, chain transfer polymerization, or living anionic polymerization, it can readily be reacted with the silyl-substituted alkyl acrylate or methacrylate monomer to form terminal hydrolyzable silyl groups.

Silyl modified polyurethanes or polyureas can, for example, be prepared by the reaction of polyurethanes or polyureas having terminal ethylenically unsaturated groups with a silyl monomer containing hydrolyzable groups and a Si—H group, for example a dialkoxyalkylsilicon hydride or trialkoxysilicon hydride.

Alternatively, ingredient (B1) may have a silicone-organic block copolymer backbone, which comprises at least one block of polyorganosiloxane groups and at least one block of an organic polymer chain. The polyorganosiloxane groups may comprise groups of formula —(R⁴_{f}SiO_{(4-f/2)}—, in which each R⁴ is independently an organic group such as a hydrocarbon group having from 1 to 18 carbon atoms, a halogenated hydrocarbon group having from 1 to 18 carbon atoms such as chloromethyl, perfluorobutyl, trifluoroethyl, and nonafluorohexyl, a hydrocarbonoxy group having up to 18 carbon atoms, or another organic group exemplified by an oxygen atom containing group such as (meth)acrylic or carboxyl; a nitrogen atom containing group such as amino-functional groups, amido-functional groups, and cyano-functional groups; a sulfur atom containing group such as mercapto groups; and subscript f has, on average, a value ranging from 1 to 3, alternatively 1.8 to 2.2.

Alternatively, each R⁴ may be a hydrocarbon group having 1 to 10 carbon atoms or a halogenated hydrocarbon group; and subscript f may be 0, 1 or 2. Examples of groups suitable for R⁴ include methyl, ethyl, propyl, butyl, vinyl, cyclohexyl, phenyl, tolyl group, a propyl group substituted with chlorine or fluorine such as 3,3,3-trifluoropropyl, chlorophenyl, beta-(perfluorobutyl)ethyl or chlorocyclohexyl group.

The organic blocks in the polymer backbone may comprise, for example, polystyrene and/or substituted polystyrenes such as poly(α-methylstyrene), poly(vinylmethylstyrene), dienes, poly(p-trimethylsilylstyrene) and poly(p-trimethylsilyl-α-methylstyrene). Other organic groups, which may be incorporated in the polymer backbone, may include acetylene terminated oligophenylenes, vinylbenzyl terminated aromatic polysulphones oligomers, aromatic polyesters, aromatic polyester based monomers, polyalkylenes, polyurethanes, aliphatic polyesters, aliphatic polyamides and aromatic polyamides.

Alternatively, the organic polymer blocks in a siloxane organic block copolymer for ingredient (B1) may be polyoxyalkylene based blocks comprising recurring oxyalkylene units, illustrated by the average formula (—C_{g}H_{2g}—O—)ₕ where subscript g is an integer with a value ranging from 2 to 4 and subscript h is an integer of at least four. The number average molecular weight (Mn) of each polyoxyalkylene polymer block may range from 300 to 10,000. Moreover, the oxyalkylene units are not necessarily identical throughout the polyoxyalkylene block, but can differ from unit to unit. A polyoxyalkylene block, for example, can comprise oxyethylene units (—C₂H₄—O—), oxypropylene units (—C₃H₆—O—) or oxybutylene units (—C₄H₈—O—), or combinations thereof. Alternatively, the polyoxyalkylene polymeric backbone may consist essentially of oxyethylene units and/or oxypropylene units. Other polyoxyalkylene blocks may include for example, units of the structure: -[—R⁵—O—(—R⁶—O—)ᵢ-Pn-CR⁷₂-Pn-O—(—R⁶—O—)ᵢ—R⁵]—, in which Pn is a 1,4-phenylene group, each R⁵ is the same or different and is a divalent hydrocarbon group having 2 to 8 carbon atoms, each R⁶ is the same or different and is an ethylene group or propylene group, each R⁷ is the same or different and is a hydrogen atom or methyl group and each of the subscripts i and j each represent a positive integer having a value ranging from 3 to 30.

Alternatively, ingredient (B1) may be a carbinol functional polyorganosiloxane. Exemplary carbinol functional polyorganosiloxanes may have unit formula [III]. Unit formula [III] is: (R⁴¹₃SiO_{1/2})ₑ(R⁴²₂SiO_{2/2})_{f}(R⁴³SiO_{3/2})_{g}(SiO_{4/2})ₕ. In unit formula [III], each R⁴¹ is independently a hydrogen atom, a monovalent hydrocarbon group such as an alkyl group of 1 to 8 carbon atoms or an aryl group; or a carbinol group; each R⁴² is independently a hydrogen atom, a monovalent hydrocarbon group such as an alkyl group of 1 to 8 carbon atoms or an aryl group, or a carbinol group; and R⁴³ is a monovalent hydrocarbon group such as an alkyl group of 1 to 8 carbon atoms or an aryl group. In unit formula [III], subscript e≧0, f≧0, g≧0, h≧0, and a quantity 0≦(e+f+g+h)≦1. Alternatively, subscript e<0.5, f≧0, g>0, h<0.5, a quantity (g+h)>0, and the quantity (e+f+g+h)=1.

As described herein, “carbinol group” is defined as any group containing at least one carbon-bonded hydroxy (COH) group. Thus the carbinol groups may contain more than one COH group such as, for example,

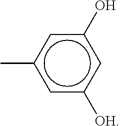

The carbon in the carbon-bonded hydroxy group may be a carbon atom in a hydrocarbon group such as alkyl or aryl or in a halogenated hydrocarbon group, such as chlorophenyl, bromophenyl, or fluorophenyl; as described below. Alternatively, the carbinol group may have formula R⁴⁴OH where R⁴⁴ is a divalent hydrocarbon group having at least 3 carbon atoms or divalent hydrocarbonoxy group having at least 3 carbon atoms. The group R⁴⁴ is illustrated by alkylene groups selected from —(CH₂)ₓ—, —CH₂CH(CH₃)—, —CH₂CH(CH₃)CH₂—, —CH₂CH₂CH(CH₂CH₃)CH₂CH₂CH₂—, and —OCH(CH₃)(CH₂)ₓ— where subscript x is 1 to 10. An aryl-containing carbinol group having at least 6 carbon atoms is illustrated by groups having the formula R⁴⁵OH wherein R⁴⁵ is an arylene group selected from —(CH₂)_{y}C₆H₄—, and —CH₂CH(CH₃)(CH₂)_{y}C₆H₄— where subscript y is 0 to 10, and —(CH₂)ₓC₆H₄(CH₂)ₓ— where subscript x is as defined above.

The carbinol-functional polyorganosiloxane may be a carbinol-functional silicone resin. Suitable carbinol-functional silicone resins are exemplified by

carbinol-functional silicone resins comprising the units:

((CH₃)₃SiO_{1/2})ₑ
((R⁴⁶)CH₃SiO_{2/2})_{f} where R⁴⁶═—(CH₂)₃C₆H₄OH
((C₆H₅)CH₃SiO_{2/2})_{f} and
(C₆H₅SiO_{3/2})_{g},

carbinol-functional silicone resins comprising the units:

((R⁴⁷)(CH₃)₂SiO_{1/2})ₑ where R⁴⁷═—(CH₂)₃C₆H₄OH and
(C₆H₅SiO_{3/2})_{g},

carbinol-functional silicone resins comprising the units:

((R⁴⁷)(CH₃)₂SiO_{1/2})ₑ where R⁴⁷═—(CH₂)₃C₆H₄OH and
(CH₃SiO_{3/2})_{g},

carbinol-functional silicone resins comprising the units:

((R⁴⁸)(CH₃)₂SiO_{1/2})ₑ where R⁴⁸═—(CH₂)₃OH and
(C₆H₅SiO_{3/2})_{g},

carbinol-functional silicone resins comprising the units:

((R⁴⁹)(CH₃)₂SiO_{1/2})ₑ where R⁴⁹═—(CH₂)₃OH
(CH₃SiO_{3/2})_{g} and
(C₆H₅SiO_{3/2})_{g},

carbinol-functional silicone resins comprising the units:

((CH₃)₃SiO_{1/2})ₑ
((R⁵⁰)CH₃SiO_{2/2})_{f} where R⁵⁰═—(CH₂)₃OH
((C₆H₅)CH₃SiO_{2/2})_{f} and
(C₆H₅SiO_{3/2})_{g},

carbinol-functional silicone resins comprising the units:

((CH₃)₃SiO_{1/2})ₑ
((R⁵¹)(CH₃)₂SiO_{1/2})ₑ where R⁵¹═—(CH₂)₃OH and
(C₆H₅SiO_{3/2})_{g}; and

carbinol-functional silicone resins comprising the units:

((R⁵²)(CH₃)₂SiO_{1/2})ₑ where R⁵²═—CH₂CH(CH₃)CH₂OH
((H)(CH₃)₂SiO_{1/2})ₑ and
(C₆H₅SiO_{3/2})_{g},
where subscript e has a total value in the resin of ≧0.2 to 0.4, f has a total value in the resin of zero to 0.4, and g has a total value in the resin of ≧0.3 to 0.8. Examples of such carbinol functional polyorganosiloxanes are disclosed in WO2008/088491 and U.S. Pat. No. 7,452,956.

Alternatively, ingredient (B1) may comprise a silicone resin, in addition to, or instead of, one of the polymers described above for ingredient (B1). Suitable silicone resins are exemplified by an MQ resin, which comprises siloxane units of the formulae: R²⁹_{w}R³⁰_{(3-w)}SiO_{1/2} and SiO_{4/2}, where R²⁹ and R³⁰ are monovalent organic groups, such as monovalent hydrocarbon groups exemplified by alkyl such as methyl, ethyl, propyl, pentyl, octyl, decyl, dodecyl, undecyl, and octadecyl; cycloalkyl such as cyclopentyl and cyclohexyl; aryl such as phenyl, tolyl, xylyl, and benzyl; and aralkyl such as 2-phenylethyl; halogenated hydrocarbon group exemplified by chlorinated alkyl groups such as chloromethyl and chloropropyl groups; fluorinated alkyl groups such as fluoromethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl; chlorinated cycloalkyl groups such as 2,2-dichlorocyclopropyl, 2,3-dichlorocyclopentyl; and fluorinated cycloalkyl groups such as 2,2-difluorocyclopropyl, 2,3-difluorocyclobutyl, 3,4-difluorocyclohexyl, and 3,4-difluoro-5-methylcycloheptyl; and other monovalent organic groups such as hydrocarbon groups substituted with oxygen atoms such as glycidoxyalkyl, and hydrocarbon groups substituted with nitrogen atoms such as aminoalkyl and cyano-functional groups such as cyanoethyl and cyanopropyl; and each instance of subscript w is 0, 1, or 2. Alternatively, each R²⁹ and each R³⁰ may be an alkyl group. The MQ resin may have a molar ratio of M units to Q units (M:Q) ranging from 0.5:1 to 1.5:1. These mole ratios are conveniently measured by Si²⁹ NMR spectroscopy. This technique is capable of quantitatively determining the concentration of R²⁹₃SiO_{1/2} (“M”) and SiO_{4/2} (“O”) units derived from the silicone resin and from the neopentamer, Si(OSiMe₃)₄, present in the initial silicone resin, in addition to the total hydroxy content of the silicone resin.

The MQ silicone resin is soluble in solvents such as liquid hydrocarbons exemplified by benzene, toluene, xylene, and heptane, or in liquid organosilicon compounds such as a low viscosity cyclic and linear polydiorganosiloxanes.

The MQ silicone resin may contain 2.0% or less, alternatively 0.7% or less, alternatively 0.3% or less, of terminal units represented by the formula X″SiO_{3/2}, where X″ represents a hydroxy group. The concentration of silanol groups present in the silicone resin can be determined using FTIR.

The Mn desired to achieve the desired flow characteristics of the MQ silicone resin can depend at least in part on the Mn of the silicone resin and the type of organic group, represented by R²⁹, that are present in this ingredient. The Mn of the MQ silicone resin is typically greater than 3,000, more typically from 4500 to 7500.

The MQ silicone resin can be prepared by any suitable method. Silicone resins of this type have reportedly been prepared by cohydrolysis of the corresponding silanes or by silica hydrosol capping methods known in the art. Briefly stated, the method involves reacting a silica hydrosol under acidic conditions with a hydrolyzable triorganosilane such as trimethylchlorosilane, a siloxane such as hexamethyldisiloxane, or a combination thereof, and recovering a product comprising M and Q units (MQ resin). The resulting MQ resins may contain from 2 to 5 percent by weight of silicon-bonded hydroxy groups.

The intermediates used to prepare the MQ silicone resin may be triorganosilanes of the formula R²⁹₃SiX′, where X′ represents a hydrolyzable group, such as halogen, alkoxy or hydroxy, and either a silane with four hydrolyzable groups such as halogen, alkoxy or hydroxy, or an alkali metal silicate such as sodium silicate.

Various suitable MQ resins are commercially available from sources such as Dow Corning Corporation of Midland, Mich., U.S.A., Momentive Performance Materials of Albany, N.Y., U.S.A., and Bluestar Silicones USA Corp. of East Brunswick, N.J., U.S.A. For example, DOW CORNING® MQ-1600 Solid Resin, DOW CORNING® MQ-1601 Solid Resin, and DOW CORNING® 1250 Surfactant, DOW CORNING® 7466 Resin, and DOW CORNING® 7366 Resin, all of which are commercially available from Dow Corning Corporation, are suitable for use in the methods described herein. Alternatively, a resin containing M, T, and Q units may be used, such as DOW CORNING® MQ-1640 Flake Resin, which is also commercially available from Dow Corning Corporation. Such resins may be supplied in organic solvent.

Alternatively, the silicone resin may comprise a silsesquioxane resin, i.e., a resin containing T units of formula (R³¹SiO_{3/2}). Each R³¹ may be independently selected from a hydrogen atom and a monovalent organic group, such as a monovalent hydrocarbon group exemplified by alkyl such as methyl, ethyl, propyl, pentyl, octyl, decyl, dodecyl, undecyl, and octadecyl; cycloalkyl such as cyclopentyl and cyclohexyl; aryl such as phenyl, tolyl, xylyl, and benzyl; and aralkyl such as 2-phenylethyl; halogenated hydrocarbon group exemplified by chlorinated alkyl groups such as chloromethyl and chloropropyl groups; a fluorinated alkyl group such as fluoromethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl; chlorinated cycloalkyl groups such as 2,2-dichlorocyclopropyl, 2,3-dichlorocyclopentyl; and fluorinated cycloalkyl groups such as 2,2-difluorocyclopropyl, 2,3-difluorocyclobutyl, 3,4-difluorocyclohexyl, and 3,4-difluoro-5-methylcycloheptyl; and another monovalent organic group such as a hydrocarbon group substituted with oxygen atoms such as glycidoxyalkyl, and a hydrocarbon group substituted with a nitrogen atom such as aminoalkyl and cyano-functional groups such as cyanoethyl and cyanopropyl. Silsesquioxane resins suitable for use herein are known in the art and are commercially available. For example, a methylmethoxysiloxane methylsilsesquioxane resin having a DP of 15 and a weight average molecular weight (Mw) of 1200 g/mol is commercially available as DOW CORNING® US-CF 2403 Resin from Dow Corning Corporation of Midland, Mich., U.S.A. Alternatively, the silsesquioxane resin may have phenylsilsesquioxane units, methylsilsesquioxane units, or a combination thereof. Such resins are known in the art and are commercially available as DOW CORNING® 200 Flake resins, also available from Dow Corning Corporation. Alternatively, the silicone resin may comprise D units of formulae (R³¹₂SiO_{2/2}) and/or (R³¹R³²SiO_{2/2}) and T units of formulae (R³¹SiO_{3/2}) and/or (R³²SiO_{3/2}), i.e., a DT resin, where R³¹ is as described above and R³² is a hydrolyzable group such as group X′ described above. DT resins are known in the art and are commercially available, for example, methoxy functional DT resins include DOW CORNING® 3074 and DOW CORNING® 3037 resins; and silanol functional resins include DOW CORNING® 800 Series resins, which are also commercially available from Dow Corning Corporation. Other suitable resins include DT resins containing methyl and phenyl groups.

The amount of silicone resin added to the composition can vary depending on the end use of the composition. For example, when the reaction product of the composition is a gel, little or no silicone resin may be added. However, the amount of silicone resin in the composition may range from 0% to 90%, alternatively 0.1% to 50%, based on the weight of all ingredients in the composition.

The amount of ingredient (B1) can depend on various factors including the end use of the reaction product of the composition, the type of hydroxy functional compound selected for ingredient (B1), and the type(s) and amount(s) of any additional ingredient(s) present, if any. However, the amount of ingredient (B1) may range from 0.01% to 99%, alternatively 10% to 95%, alternatively 10% to 65% of the composition.

Ingredient (B1) can be one single —OH functional compound or a combination comprising two or more —OH functional compounds that differ in at least one of the following properties: average molecular weight, hydrolyzable substituents, siloxane units, sequence, and viscosity.

Ingredient (B2) is a Si—R⁵⁰ functional compound, i.e., a compound having an average, per molecule, of one or more silicon bonded R⁵⁰ moieties, where R⁵⁰ may be a hydrogen atom or a hydrocarbonoxy group. The hydrocarbonoxy group may have formula —O-A″, as described above. Alternatively, ingredient (B2) may have 2 or more silicon bonded R⁵⁰ moieties. In one embodiment, each R⁵⁰ may be a hydrogen atom. Alternatively, each R⁵⁰ may be a hydrocarbonoxy group. Ingredient (B2) may comprise a silane and/or a polymeric organosilicon compound. The organosilicon compound for ingredient (B2) may be selected from a polyorganosiloxane such as a polydiorganosiloxane, an organic polymer, or a silicone-organic copolymer (having the one or more R⁵⁰ moieties covalently bonded to a Si atom in the polymer backbone and/or terminus). Alternatively, ingredient (B2) may be a polyorganosiloxane, or an organic polymer. Alternatively ingredient (B2) may be a polyorganosiloxane. The R⁵⁰ moiety in ingredient (B2) may be located at terminal, pendant, or both terminal and pendant positions in the polymer. Ingredient (B2) may comprise a linear, branched, cyclic, or resinous structure. Alternatively, ingredient (B2) may comprise a linear, branched or cyclic structure. Alternatively, ingredient (B2) may comprise a linear or branched structure. Alternatively, ingredient (B2) may comprise a linear structure. Alternatively, ingredient (B2) may comprise a linear structure and a resinous structure. Ingredient (B2) may comprise a homopolymer or a copolymer or a combination thereof.

Ingredient (B2) may comprise a silane of formula R⁵¹ₑSiR⁵⁰_{f}, where subscript e is 0, 1, 2, or 3; and subscript f is 1, 2, 3, or 4, with the proviso that a sum of (e+f) is 4. Each R⁵⁰ is a hydrogen atom or a hydrocarbonoxy group. Suitable hydrocarbonoxy groups for R⁵⁰ include alkoxy such as methoxy, ethoxy, propoxy and butoxy; alternatively alkenyloxy such as CH₂═CH(O). Each R⁵¹ is independently a halogen atom or a monovalent organic group. Suitable halogen atoms for R⁵¹ are exemplified by chlorine, fluorine, bromine, and iodine; alternatively chlorine. Suitable monovalent organic groups for R⁵¹ include, but are not limited to, monovalent hydrocarbon and monovalent halogenated hydrocarbon groups. Monovalent hydrocarbon groups include, but are not limited to, alkyl such Me, Et, Pr, Bu, pentyl, hexyl, heptyl, octyl, decyl, dodecyl, undecyl, and octadecyl; cycloalkyl such as cyclopentyl and cyclohexyl; aryl such as Ph, tolyl, xylyl, and naphthyl; and aralkyl such as benzyl, 1-phenylethyl and 2-phenylethyl. Examples of monovalent halogenated hydrocarbon groups include, but are not limited to, chlorinated alkyl groups such as chloromethyl and chloropropyl groups; fluorinated alkyl groups such as fluoromethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl; chlorinated cycloalkyl groups such as 2,2-dichlorocyclopropyl, 2,3-dichlorocyclopentyl; and fluorinated cycloalkyl groups such as 2,2-difluorocyclopropyl, 2,3-difluorocyclobutyl, 3,4-difluorocyclohexyl, and 3,4-difluoro-5-methylcycloheptyl. Examples of other monovalent organic groups include, but are not limited to, hydrocarbon groups substituted with oxygen atoms such as glycidoxyalkyl, and alkoxy groups such as methoxy, ethoxy, propoxy, and butoxy; and hydrocarbon groups substituted with nitrogen atoms such as aminoalkyl and cyano-functional groups such as cyanoethyl and cyanopropyl. Examples of suitable Si—H functional silanes for ingredient (B2) are exemplified by trichlorosilane (HSiCl₃), Me₂HSiCl, or MeHSi(OMe)₂. Examples of suitable alkoxysilanes for ingredient (B2) include methyltrimethoxysilane, and those alkoxysilanes listed below as crosslinkers for ingredient (C).

Ingredient (B2) may have the R⁵⁰ moieties contained in groups of the formula (ii):

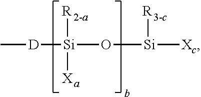

where each D independently represents an oxygen atom, a divalent organic group, a divalent silicone organic group, or a combination of a divalent hydrocarbon group and a divalent siloxane group; each X independently represents a hydrogen atom or a hydrocarbonoxy group; each R independently represents a monovalent hydrocarbon group; subscript c represents 0, 1, 2, or 3; subscript a represents 0, 1, or 2; and subscript b has a value of ≧0 or greater, with the proviso that the sum of (a+c) is at least 1, such that, on average, at least one X is present in the formula. Alternatively, subscript b may have a value ranging from 0 to 4,000, alternatively 0 to 18. Alternatively, each X may be a hydrogen atom. Alternatively, each X may be an alkoxy group.

Alternatively, each D may be independently selected from an oxygen atom and a divalent hydrocarbon group. Alternatively, each D may be an oxygen atom. Alternatively, each D may be a divalent hydrocarbon group exemplified by an alkylene group such as ethylene, propylene, butylene, or hexylene; an arylene group such as phenylene, or an alkylarylene group such as:

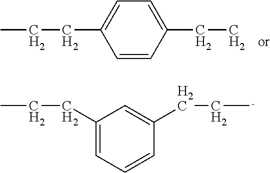

Alternatively, an instance of D may be an oxygen atom while a different instance of D is a divalent hydrocarbon group.

Alternatively, each R in the formula above may be independently selected from alkyl groups of 1 to 20 carbon atoms, aryl groups of 6 to 20 carbon atoms, and aralkyl groups of 7 to 20 carbon atoms.

Alternatively, subscript b may be 0.

Ingredient (B2) may comprise the groups described by formula (ii) above in an amount of the polymer ranging from 0.2 mol % to 10 mol %, alternatively 0.5 mol % to 5 mol %, alternatively 0.5 mol % to 2.0 mol %, alternatively 0.5 mol % to 1.5 mol %, and alternatively 0.6 mol % to 1.2 mol %.

Ingredient (B2) may be a polyorganosiloxane with a linear structure, i.e., a polydiorganosiloxane. When ingredient (B2) is a polydiorganosiloxane, ingredient (B2) may comprise a hydrido-endblocked polydiorganosiloxane, an hydridosilylhydrocarbylene-endblocked polydiorganosiloxane, or a combination thereof.

Ingredient (B2) may comprise a polydiorganosiloxane of unit formula (I): (R⁵⁰_{d}R²_{(3-d)}SiR³_{1/2})₂(R²₂SiO_{2/2})ₑ(R⁵⁰R²SiO_{2/2})_{f}, Where each R⁵⁰ is as described above, each R² is independently a monovalent organic group, each R³ is independently an oxygen atom or a divalent hydrocarbon group, each subscript d is independently 0, 1, 2, or 3, e is ≧0, f≧0, and a quantity (e+f) is an integer having a value sufficient to provide the polydiorganosiloxane with a viscosity of at least 100 mPa·s at 25° C. and/or a DP of at least 87. DP may be measured by GPC using polystyrene standards calibration. Alternatively, subscript e may have a value ranging from 1 to 200,000.

Suitable organic groups for R² include, but are not limited to, monovalent organic groups such as hydrocarbon groups and halogenated hydrocarbon groups. Examples of monovalent hydrocarbon groups for R² include, but are not limited to, alkyl such as methyl, ethyl, propyl, pentyl, octyl, decyl, dodecyl, undecyl, and octadecyl; cycloalkyl such as cyclopentyl and cyclohexyl; aryl such as phenyl, tolyl, xylyl, and benzyl; and aralkyl such as 2-phenylethyl. Examples of monovalent halogenated hydrocarbon groups for R² include, but are not limited to, chlorinated alkyl groups such as chloromethyl and chloropropyl groups; fluorinated alkyl groups such as fluoromethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl; chlorinated cycloalkyl groups such as 2,2-dichlorocyclopropyl, 2,3-dichlorocyclopentyl; and fluorinated cycloalkyl groups such as 2,2-difluorocyclopropyl, 2,3-difluorocyclobutyl, 3,4-difluorocyclohexyl, and 3,4-difluoro-5-methylcycloheptyl. Examples of other monovalent organic groups for R² include, but are not limited to, hydrocarbon groups substituted with oxygen atoms such as glycidoxyalkyl, and hydrocarbon groups substituted with nitrogen atoms such as aminoalkyl and cyano-functional groups such as cyanoethyl and cyanopropyl. Alternatively, each R² may be an alkyl group such as methyl.

Ingredient (B2) may comprise an α,ω-hydrido-polydiorganosiloxane when, in formula (I) above, each subscript d is 1, subscript f is 0, and each R³ is an oxygen atom. For example, ingredient (B2) may have formula (II): HR²₂SiO—(R²₂SiO)_{e′}—SiR²₂H, where R² is as described above and subscript e′ is an integer having a value sufficient to give the polydiorganosiloxane of formula (II) the viscosity described above. Alternatively, subscript e′ may have a value ranging from 1 to 200,000, alternatively 50 to 1,000, and alternatively 200 to 700.

Alternatively, in formula (II) described above, each R² may be an alkyl group such as methyl, and subscript e′ may have a value such that the Si—H functional polydiorganosiloxane has a viscosity of at least 100 mPa·s at 25° C. Alternatively, subscript e′ may have a value ranging from 50 to 700. Exemplary Si—H-endblocked polydiorganosiloxanes are hydrido-endblocked polydimethylsiloxanes. Hydrido-endblocked polydiorganosiloxanes suitable for use as ingredient (B2) may be prepared by methods known in the art, such as hydrolysis and condensation of the corresponding organohalosilanes or equilibration of cyclic polydiorganosiloxanes.

The amount of ingredient (B2) can depend on various factors including the end use of the reaction product of the composition, the type of Si—R⁵⁰ functional compound selected for ingredient (B2), and the type(s) and amount(s) of any additional ingredient(s) present, if any. However, the amount of ingredient (B2) may range from 0.01% to 99%, alternatively 0.1% to 10%, alternatively 1% to 5%, alternatively 1% to 2%, alternatively 10% to 95%, and alternatively 10% to 65% of the composition.

Ingredient (B2) can be one single Si—R⁵⁰ functional compound or a combination comprising two or more Si—R⁵⁰ functional compounds that differ in at least one of the following properties: average molecular weight, hydrolyzable substituents, siloxane units, sequence, and viscosity.

The composition may optionally further comprise one or more additional ingredients, i.e., in addition to ingredients (A), (B1) and (B2) and distinct from ingredients (A), (B1) and (B2). The additional ingredient, if present, may be selected based on factors such as the method of use of the composition and/or the end use of the cured product of the composition. The additional ingredient may be: (C) a crosslinker; (D) a drying agent; (E) an extender, a plasticizer, or a combination thereof; (F) a filler such as (f1) a reinforcing filler, (f2) an extending filler, (f3) a conductive filler (e.g., electrically conductive, thermally conductive, or both); (G) a filler treating agent; (H) a biocide, such as (h1) a fungicide, (h2) an herbicide, (h3) a pesticide, or (h4) an antimicrobial; (J) a flame retardant; (K) a surface modifier such as (k1) an adhesion promoter or (k2) a release agent; (L) a chain lengthener; (M) an endblocker; (N) a nonreactive binder; (O) an anti-aging additive; (P) a water release agent; (Q) a pigment; (R) a rheological additive; (S) a vehicle; (T) a tackifying agent; (U) a corrosion inhibitor; and a combination thereof. The additional ingredients are distinct from one another. In some embodiments at least one, alternatively each of additional ingredients (C) to (U), and the combination thereof, does not completely prevent the condensation reaction of ingredient (B1) and (B2).

Ingredient (C) is a crosslinker that may be added to the composition, for example, to increase crosslink density of the reaction product prepared by condensation reaction of the composition. Generally, ingredient (C) is selected with functionality that can vary depending on the degree of crosslinking desired in the reaction product of the composition and such that the reaction product does not exhibit too much weight loss from by-products of the condensation reaction. Generally, the selection of ingredient (C) is made such that the composition remains sufficiently reactable to be useful during storage for several months in a moisture impermeable package. Generally, ingredient (C) is selected such that the hydrolyzable substituents on ingredient (C) are reactive with the hydroxy groups on ingredient (B1). For example, the hydrolyzable substituent for ingredient (C) may be a hydrogen atom, a halogen atom; an amido group, an acyloxy groups, a hydrocarbonoxy group, an amino group, an aminoxy group, a mercapto group, an oximo group, a ketoximo group, or an alkoxysilylhydrocarbylene group, or a combination thereof. The exact amount of ingredient (C) can vary depending on factors including the type of hydroxy-functional compound for (B1) and crosslinker (C) selected, the reactivity of the hydroxy groups on ingredient (B1) and reactivity of crosslinker (C), and the desired crosslink density of the reaction product. However, the amount of crosslinker may range from 0.5 to 100 parts based on 100 parts by weight of ingredient (B1).

Ingredient (C) may comprise a silane crosslinker having hydrolyzable groups or partial or full hydrolysis products thereof. Ingredient (C) has an average, per molecule, of greater than two substituents reactive with the hydroxy groups on ingredient (B1). Examples of suitable silane crosslinkers for ingredient (C) may have the general formula (III) R⁸ₖSi(R⁹)₍₄₋ₖ₎, where each R⁸ is independently a monovalent hydrocarbon group such as an alkyl group; each R⁹ is a hydrolyzable substituent, which may be the same as X described above for ingredient (B1). Alternatively, each R⁹ may be, for example, a hydrogen atom, a halogen atom, an acetamido group, an acyloxy group such as acetoxy, an alkoxy group, an amido group, an amino group, an aminoxy group, a hydroxy group, an oximo group, a ketoximo group, or a methylacetamido group; and each instance of subscript k may be 0, 1, 2, or 3. For ingredient (C), subscript k has an average value greater than 2. Alternatively, subscript k may have a value ranging from 3 to 4. Alternatively, each R⁹ may be independently selected from hydroxy, alkoxy, acetoxy, amide, or oxime. Alternatively, ingredient (C) may be selected from an acyloxysilane, an alkoxysilane, a ketoximosilane, and an oximosilane.

Ingredient (C) may comprise an alkoxysilane exemplified by a dialkoxysilane, such as a dialkyldialkoxysilane; a trialkoxysilane, such as an alkyltrialkoxysilane; a tetraalkoxysilane; or partial or full hydrolysis products thereof, or another combination thereof. Examples of suitable trialkoxysilanes include methyltrimethoxysilane, methyltriethoxysilane, ethyltrimethoxysilane, ethyltriethoxysilane, isobutyltrimethoxysilane, isobutyltriethoxysilane, and a combination thereof, and alternatively methyltrimethoxysilane. Examples of suitable tetraalkoxysilanes include tetraethoxysilane. The amount of the alkoxysilane that is used in the curable silicone composition may range from 0.5 to 15, parts by weight per 100 parts by weight of ingredient (B1).

Alternatively, ingredient (C) may comprise an acyloxysilane, such as an acetoxysilane, e.g., methyltriacetoxysilane, ethyltriacetoxysilane, and combinations thereof. Alternatively, ingredient (C) may comprise a silane containing both alkoxy and acetoxy groups, e.g., methyldiacetoxymethoxysilane, methylacetoxydimethoxysilane, vinyldiacetoxymethoxysilane, vinylacetoxydimethoxysilane, methyldiacetoxyethoxysilane, metylacetoxydiethoxysilane, and combinations thereof. Alternatively, ingredient (C) may comprise an aminofunctional alkoxysilane. Alternatively, ingredient (C) may comprise an oximosilane and/or a ketoximosilane. Alternatively, ingredient (C) may be polymeric. For example, ingredient (C) may comprise a disilane such as bis(triethoxysilyl)hexane), 1,4-bis[trimethoxysilyl(ethyl)]benzene, and bis[3-(triethoxysilyl)propyl] tetrasulfide

Ingredient (C) can be one single crosslinker or a combination comprising two or more crosslinkers that differ in at least one of the following properties: hydrolyzable substituents and other organic groups bonded to silicon, and when a polymeric crosslinker is used, siloxane units, structure, molecular weight, and sequence. Examples of suitable crosslinkers for ingredient (C) are exemplified by those described, for example, in PCT Publication No. WO2013/009836.

Ingredient (D) is a drying agent. The drying agent binds water from various sources. For example, the drying agent may bind by-products of the condensation reaction, such as water and alcohols. The drying agent may be a physical drying agent and/or a chemical drying agent. Examples of physical drying agents are adsorbents. Suitable adsorbents for ingredient (D) may be inorganic particulates. Examples of adsorbents include zeolites such as chabasite, mordenite, and analcite; molecular sieves such as alkali metal alumino silicates, silica gel, silica-magnesia gel, activated carbon, activated alumina, calcium oxide, and combinations thereof.

Alternatively, the drying agent may bind the water by chemical means. An amount of a silane crosslinker added to the composition (in addition to ingredient (C)) may function as a chemical drying agent. Without wishing to be bound by theory, it is thought that the chemical drying agent may be added to the dry part of a multiple part composition to keep the composition free from water after the parts of the composition are mixed together. For example, alkoxysilanes suitable as drying agents include vinyltrimethoxysilane, vinyltriethoxysilane, and combinations thereof. Examples of suitable drying agents for ingredient (D) are exemplified by those described, for example, in PCT Publication No. WO2013/009836

The amount of ingredient (D) depends on the specific drying agent selected. However, when ingredient (D) is a chemical drying agent, the amount may range from 0 parts to 5 parts, alternatively 0.1 parts to 0.5 parts. Ingredient (D) may be one chemical drying agent. Alternatively, ingredient (D) may comprise two or more different chemical drying agents.

Ingredient (E) is an extender and/or a plasticizer. An extender comprising a non-functional polyorganosiloxane may be used in the composition. For example, the non-functional polyorganosiloxane may comprise difunctional units of the formula R²²₂SiO_{2/2} and terminal units of the formula R²³₃SiD′-, where each R²² and each R²³ are independently a monovalent organic group such as a monovalent hydrocarbon group; and D′ is an oxygen atom or a divalent group linking the silicon atom of the terminal unit with another silicon atom (such as group D described above for ingredient (B1)), alternatively D′ is an oxygen atom. Non-functional polyorganosiloxanes are known in the art and are commercially available. Suitable non-functional polyorganosiloxanes are exemplified by, but not limited to, polydimethylsiloxanes. Such polydimethylsiloxanes include DOW CORNING® 200 Fluids, which are commercially available from Dow Corning Corporation of Midland, Mich., U.S.A. and may have viscosity ranging from 50 cSt to 100,000 cSt, alternatively 50 cSt to 50,000 cSt, and alternatively 12,500 to 60,000 cSt.

An organic plasticizer may be used in addition to, or instead of, the non-functional polyorganosiloxane extender described above. Organic plasticizers are known in the art and are commercially available. The organic plasticizer may comprise a phthalate, a carboxylate, a carboxylic acid ester, an adipate or a combination thereof. The organic plasticizer may be selected from the group consisting of: bis(2-ethylhexyl) terephthalate; bis(2-ethylhexyl)-1,4-benzenedicarboxylate; 2-ethylhexyl methyl-1,4-benzenedicarboxylate; 1,2 cyclohexanedicarboxylic acid, dinonyl ester, branched and linear; bis(2-propylheptyl) phthalate; diisononyl adipate; and a combination thereof. When the organic plasticizer is present, the amount of the organic plasticizer may range from 5 to 150 parts by weight based on the combined weights of all ingredients in the composition.

The polyorganosiloxane extenders and organic plasticizers described above for ingredient (E) may be used either each alone or in combinations of two or more thereof. A low molecular weight organic plasticizer and a higher molecular weight polymer plasticizer may be used in combination. Examples of suitable plasticizers for ingredient (E) are exemplified by those described, for example, in PCT Publication No. WO2013/009836. The exact amount of ingredient (E) used in the composition can depend on various factors including the desired end use of the composition and the cured product thereof. However, the amount of ingredient (E) may range from 0.1% to 10% based on the combined weights of all ingredients in the composition.

Ingredient (F) is a filler. The filler may comprise a reinforcing filler, an extending filler, a conductive filler, or a combination thereof. For example, the composition may optionally further comprise ingredient (f1), a reinforcing filler, which when present may be added in an amount ranging from 0.1% to 95%, alternatively 1% to 60%, based on the weight of the composition. The exact amount of ingredient (f1) depends on various factors including the form of the reaction product of the composition and whether any other fillers are added. Examples of suitable reinforcing fillers include reinforcing silica fillers such as fume silica, silica aerogel, silica xerogel, and precipitated silica. Fumed silicas are known in the art and commercially available.

The composition may optionally further comprise ingredient (f2) an extending filler in an amount ranging from 0.1% to 95%, alternatively 1% to 60%, and alternatively 1 to 20%, based on the weight of the composition. Examples of extending fillers include crushed quartz, aluminum oxide, magnesium oxide, calcium carbonate such as precipitated calcium carbonate, zinc oxide, talc, diatomaceous earth, iron oxide, clays, mica, chalk, titanium dioxide, zirconia, sand, carbon black, graphite, or a combination thereof. Extending fillers are known in the art and commercially available.

The composition may optionally further comprise ingredient (f3) a conductive filler. Conductive fillers may be thermally conductive, electrically conductive, or both. Conductive fillers are known in the art and are exemplified by metal particulates (such as aluminum, copper, gold, nickel, silver, and combinations thereof); such metals coated on nonconductive substrates; metal oxides (such as aluminum oxide, beryllium oxide, magnesium oxide, zinc oxide, and combinations thereof), meltable fillers (e.g., solder), aluminum nitride, aluminum trihydrate, barium titanate, boron nitride, carbon fibers, diamond, graphite, magnesium hydroxide, onyx, silicon carbide, tungsten carbide, and a combination thereof.

Alternatively, other fillers may be added to the composition, the type and amount depending on factors including the end use of the cured product of the composition. Examples of such other fillers include magnetic particles such as ferrite; and dielectric particles such as fused glass microspheres, titania, and calcium carbonate. Examples of suitable fillers for ingredient (F) are exemplified by those described, for example, in PCT Publication No. WO2013/009836.

The composition may optionally further comprise ingredient (G) a treating agent. The amount of ingredient (G) can vary depending on factors such as the type of treating agent selected and the type and amount of particulates to be treated, and whether the particulates are treated before being added to the composition, or whether the particulates are treated in situ. However, ingredient (G) may be used in an amount ranging from 0.01 to 20%, alternatively 0.1% to 15%, and alternatively 0.5% to 5%, based on the weight of the composition. Particulates, such as the filler, the physical drying agent, certain flame retardants, certain pigments, and/or certain water release agents, when present, may optionally be surface treated with ingredient (G). Particulates may be treated with ingredient (G) before being added to the composition, or in situ. Ingredient (G) may comprise an alkoxysilane, an alkoxy-functional oligosiloxane, a cyclic polyorganosiloxane, a hydroxy-functional oligosiloxane such as a dimethyl siloxane or methyl phenyl siloxane, or a fatty acid. Examples of fatty acids include stearates such as calcium stearate.

Some representative organosilicon filler treating agents that can be used as ingredient (G) include compositions normally used to treat silica fillers such as organochlorosilanes, organosiloxanes, organodisilazanes such as hexaalkyl disilazane, and organoalkoxysilanes such as C₆H₁₃Si(OCH₃)₃, C₈H₁₇Si(OC₂H₅)₃, C₁₀H₂₁Si(OCH₃)₃, C₁₂H₂₅Si(OCH₃)₃, C₁₄H₂₉Si(OC₂H₅)₃, and C₆H₅CH₂CH₂Si(OCH₃)₃. Other treating agents that can be used include alkylthiols, fatty acids, titanates, titanate coupling agents, zirconate coupling agents, and combinations thereof.

Alternatively, ingredient (G) may comprise an alkoxysilane having the formula: R¹³ₚSi(OR¹⁴)₍₄₋ₚ₎, where subscript p may have a value ranging from 1 to 3, alternatively subscript p is 3. Each R¹³ is independently a monovalent organic group, such as a monovalent hydrocarbon group of 1 to 50 carbon atoms, alternatively 8 to 30 carbon atoms, alternatively 8 to 18 carbon atoms. R¹³ is exemplified by alkyl groups such as hexyl, octyl, dodecyl, tetradecyl, hexadecyl, and octadecyl; and aromatic groups such as benzyl and phenylethyl. R¹³ may be saturated or unsaturated, and branched or unbranched. Alternatively, R¹³ may be saturated and unbranched.

Each R¹⁴ is independently a saturated hydrocarbon group of 1 to 4 carbon atoms, alternatively 1 to 2 carbon atoms. Ingredient (G) is exemplified by hexyltrimethoxysilane, octyltriethoxysilane, decyltrimethoxysilane, dodecyltrimethoxysilane, tetradecyltrimethoxysilane, phenylethyltrimethoxysilane, octadecyltrimethoxysilane, octadecyltriethoxysilane, and combinations thereof.

Alkoxy-functional oligosiloxanes may also be used as treating agents. For example, suitable alkoxy-functional oligosiloxanes include those of the formula (R¹⁵O)_{q}Si(OSiR¹⁶₂R¹⁷)_{(4-q)}. In this formula, subscript q is 1, 2 or 3, alternatively subscript q is 3. Each R¹⁵ may be an alkyl group. Each R¹⁶ may be an unsaturated monovalent hydrocarbon group of 1 to 10 carbon atoms. Each R¹⁷ may be an unsaturated monovalent hydrocarbon group having at least 10 carbon atoms.

Certain particulates, such as metal fillers may be treated with alkylthiols such as octadecyl mercaptan; fatty acids such as oleic acid and stearic acid; and a combination thereof.

Other treating agents include alkenyl functional polyorganosiloxanes. Suitable alkenyl functional polyorganosiloxanes include, but are not limited to:

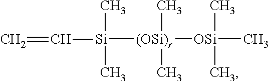

where subscript r has a value up to 1,500. Examples of suitable treating agents for ingredient (G) are exemplified by those described, for example, in PCT Publication No. WO2013/009836.

Ingredient (H) is a biocide. The amount of ingredient (H) can vary depending on factors including the type of biocide selected and the benefit desired. However, the amount of ingredient (H) may range from greater than 0% to 5% based on the weight of all ingredients in the composition. Ingredient (H) is exemplified by (h1) a fungicide, (h2) an herbicide, (h3) a pesticide, (h4) an antimicrobial, or a combination thereof. Examples of suitable biocides are known in the art and are disclosed, for example, in PCT Publication No. WO2013/009836.

Ingredient (J) is a flame retardant. Suitable flame retardants may include, for example, carbon black, hydrated aluminum hydroxide, and silicates such as wollastonite, platinum and platinum compounds. Alternatively, the flame retardant may be selected from halogen based flame-retardants. Alternatively, the flame retardant may be selected from phosphorus based flame-retardants. Examples of suitable flame retardants for ingredient (J) are exemplified by those described, for example, in PCT Publication No. WO2013/009836.

The amount of flame retardant can vary depending on factors such as the flame retardant selected and whether solvent is present. However, the amount of flame retardant in the composition may range from greater than 0% to 10% based on the combined weight of all ingredients in the composition.

Ingredient (K) is a surface modifier. Suitable surface modifiers are exemplified by (k1) an adhesion promoter or (k2) a release agent. Suitable adhesion promoters for ingredient (k1) may comprise a transition metal chelate, a hydrocarbonoxysilane such as an alkoxysilane, a combination of an alkoxysilane and a hydroxy-functional polyorganosiloxane, an aminofunctional silane, or a combination thereof. Adhesion promoters are known in the art and may comprise silanes having the formula R²⁴ₜR²⁵ᵤSi(OR²⁶)₄₋₍ₜ₊ᵤ₎ where each R²⁴ is independently a monovalent organic group having at least 3 carbon atoms; R²⁵ contains at least one SiC bonded substituent having an adhesion-promoting group, such as amino, epoxy, mercapto or acrylate groups; subscript t has a value ranging from 0 to 2; subscript u is either 1 or 2; and the sum of (t+u) is not greater than 3. Each R²⁶ is independently a saturated hydrocarbon group. Saturated hydrocarbon groups for R²⁶ may be, for example, an alkyl group of 1 to 4 carbon atoms, alternatively 1 to 2 carbon atoms. R²⁶ is exemplified by methyl, ethyl, propyl, and butyl. Alternatively, the adhesion promoter may comprise a partial condensate of the above silane. Alternatively, the adhesion promoter may comprise a partial condensate of the above silane. Alternatively, the adhesion promoter may comprise a combination of an alkoxysilane and a hydroxy-functional polyorganosiloxane. Examples of suitable surface modifiers for ingredient (K) are exemplified by those described, for example, in PCT Publication No. WO2013/009836.

The exact amount of ingredient (K) depends on various factors including the type of surface modifier selected as ingredient (K) and the end use of the composition and its reaction product. However, ingredient (K), when present, may be added to the composition in an amount ranging from 0.01 to 50 weight parts based on the weight of the composition, alternatively 0.01 to 10 weight parts, and alternatively 0.01 to 5 weight parts. Ingredient (K) may be one adhesion promoter. Alternatively, ingredient (K) may comprise two or more different surface modifiers that differ in at least one of the following properties: structure, viscosity, average molecular weight, polymer units, and sequence.

Chain lengtheners may include difunctional silanes and difunctional siloxanes, which extend the length of polyorganosiloxane chains before crosslinking occurs. Chain lengtheners may be used to reduce the modulus of elongation of the cured product. Chain lengtheners and crosslinkers compete in their reactions with the hydroxy groups in ingredient (B1). To achieve noticeable chain extension, the difunctional silane has substantially higher reactivity than the trifunctional crosslinker with which it is used. Suitable chain lengtheners include diamidosilanes such as dialkyldiacetamidosilanes or alkenylalkyldiacetamidosilanes, particularly methylvinyldi(N-methylacetamido)silane, or dimethyldi(N-methylacetamido)silane, diacetoxysilanes such as dialkyldiacetoxysilanes or alkylalkenyldiacetoxysilanes, diaminosilanes such as dialkyldiaminosilanes or alkylalkenyldiaminosilanes, dialkoxysilanes such as dimethyldimethoxysilane, dimethyldiethoxysilane and α-aminoalkyldialkoxyalkylsilanes, polydialkylsiloxanes having a degree of polymerization of from 2 to 25 and having an average per molecule of at least two hydrolyzable groups, such as acetamido or acetoxy or amino or alkoxy or amido or ketoximo substituents, and diketoximinosilanes such as dialkylkdiketoximinosilanes and alkylalkenyldiketoximinosilanes. Ingredient (L) may be one chain lengthener. Alternatively, ingredient (L) may comprise two or more different chain lengtheners that differ in at least one of the following properties: structure, viscosity, average molecular weight, polymer units, and sequence.

Ingredient (M) is and endblocker comprising an M unit, i.e., a siloxane unit of formula R²⁹₃SiO_{1/2}, where each R²⁹ independently represents a monovalent organic group unreactive with ingredient (B1), such as a monovalent hydrocarbon group. Ingredient (M) may comprise polyorganosiloxanes endblocked on one terminal end by a triorganosilyl group, e.g., (CH₃)₃SiO—, and on the other end by a hydroxy group. Ingredient (M) may be a polydiorganosiloxane such as a polydimethylsiloxane. The polydiorganosiloxanes having both hydroxy end groups and triorganosilyl end groups, may have more than 50%, alternatively more than 75%, of the total end groups as hydroxy groups. The amount of triorganosilyl group in the polydimethylsiloxane may be used to regulate the modulus of the reaction product prepared by condensation reaction of the composition. Without wishing to be bound by theory, it is thought that higher concentrations of triorganosilyl end groups may provide a lower modulus in certain cured products. Ingredient (M) may be one endblocker. Alternatively, ingredient (M) may comprise two or more different endblockers that differ in at least one of the following properties: structure, viscosity, average molecular weight, polymer units, and sequence.

Ingredient (N) is a non-reactive, elastomeric, organic polymer, i.e., an elastomeric organic polymer that does not react with ingredient (B1). Ingredient (N) is compatible with ingredient (B1), i.e., ingredient (N) does not form a two-phase system with ingredient (B1). Ingredient (N) may have low gas and moisture permeability. Ingredient (N) may have Mn ranging from 30,000 to 75,000. Alternatively, ingredient (N) may be a blend of a higher molecular weight, non-reactive, elastomeric, organic polymer with a lower molecular weight, non-reactive, elastomeric, organic polymer. In this case, the higher molecular weight polymer may have Mn ranging from 100,000 to 600,000 and the lower molecular weight polymer may have Mn ranging from 900 to 10,000, alternatively 900 to 3,000. The value for the lower end of the range for Mn may be selected such that ingredient (N) has compatibility with ingredient (B1) and the other ingredients of the composition.

Ingredient (N) may comprise a polyisobutylene. Polyisobutylenes are known in the art and are commercially available. Alternatively, ingredient (N) may comprise butyl rubber. Alternatively, ingredient (N) may comprise a styrene-ethylene/butylene-styrene (SEBS) block copolymer, a styrene-ethylene/propylene-styrene (SEPS) block copolymer, or a combination thereof. Examples of nonreactive binders are known in the art and are commercially available. A description may be found in PCT Publication No. WO 2013/009836.

The amount of ingredient (N) may range from 0 parts to 50 parts, alternatively 10 parts to 40 parts, and alternatively 5 parts to 35 parts, based on the weight of the composition. Ingredient (N) may be one non-reactive, elastomeric, organic polymer. Alternatively, ingredient (N) may comprise two or more non-reactive, elastomeric, organic polymers that differ in at least one of the following properties: structure, viscosity, average molecular weight, polymer units, and sequence. Alternatively, ingredient (N) may be added to the composition when ingredient (B1) comprises a base polymer with an organic polymer backbone.

Ingredient (O) is an anti-aging additive. The anti-aging additive may comprise an antioxidant, a UV absorber, a UV stabilizer, a heat stabilizer, or a combination thereof. Suitable antioxidants are known in the art and are commercially available. Examples of suitable anti-aging additives for ingredient (O) are exemplified by those described, for example, in PCT Publication No. WO2013/009836.

The amount of ingredient (O) depends on various factors including the specific anti-aging additive selected and the anti-aging benefit desired. However, the amount of ingredient (O) may range from 0 to 5 weight %, alternatively 0.1% to 4%, and alternatively 0.5% to 3%, based on the weight of the composition. Ingredient (O) may be one anti-aging additive. Alternatively, ingredient (O) may comprise two or more different anti-aging additives.

Ingredient (P) is a water release agent that releases water over an application temperature range. Ingredient (P) is selected such that ingredient (P) contains an amount of water sufficient to partially or fully react the composition and such that ingredient (P) releases the sufficient amount of water when exposed for a sufficient amount of time to a use temperature (i.e., a temperature at which the composition is used). However, ingredient (P) binds the water sufficiently to prevent too much water from being released during the method for making the composition and during storage of the composition. For example, ingredient (P) binds the water sufficiently during compounding of the composition such that sufficient water is available for condensation reaction of the composition during or after the application process in which the composition is used. This “controlled release” property also may provide the benefit of ensuring that not too much water is released too rapidly during the application process, since this may cause bubbling or voiding in the reaction product formed by condensation reaction of the composition. Precipitated calcium carbonate may be used as ingredient (P) when the application temperature ranges from 80° C. to 120° C., alternatively 90° C. to 110° C., and alternatively 90° C. to 100° C. However, when the composition is prepared on a continuous (e.g., twin-screw) compounder, the ingredients may be compounded at a temperature 20° C. to 30° C. above the application temperature range for a short amount of time. Therefore, ingredient (P) is selected to ensure that not all of the water content is released during compounding; however ingredient (P) releases a sufficient amount of water for condensation reaction of the composition when exposed to the application temperature range for a sufficient period of time.

Examples of suitable water release agents are exemplified by metal salt hydrates, hydrated molecular sieves, and precipitated calcium carbonate, which is available from Solvay under the trademark WINNOFIL® SPM. The water release agent selected can depend on various factors including the other ingredients selected for the composition, including catalyst type and amount; and the process conditions during compounding, packaging, and application. In a twin-screw compounder, residence time may be less than a few minutes, typically less than 1 to 2 minutes. The ingredients are heated rapidly because the surface area/volume ratio in the barrels and along the screw is high and heat is induced by shearing the ingredients. How much water is removed from ingredient (P) depends on the water binding capabilities, the temperature, the exposure time (duration), and the level of vacuum used to strip the composition passing through the compounder. Without wishing to be bound by theory, it is thought that with a twin screw compounding temperature of 120° C. there would remain enough water on the precipitated CaCO₃ to cause the composition to react by condensation reaction over a period of 1 to 2 weeks at room temperature when the composition has been applied at 90° C.

A water release agent may be added to the composition, for example, when the base polymer has low water permeability (e.g., when the base polymer has an organic polymer backbone) and/or the amount of ingredient (P) in the composition depends on various factors including the selection of ingredients (A), (B1) and (B2) and whether any additional ingredients are present, however the amount of ingredient (P) may range from 5 to 30 parts based on the weight of the composition.

Without wishing to be bound by theory, it is thought when the composition is heated to the application temperature, the heat would liberate the water, and the water would react with the hydroxy groups on ingredient (B1) to react the composition. By-products such as alcohols and/or water left in the composition may be bound by a drying agent, thereby allowing the condensation reaction (which is an equilibrium reaction) to proceed toward completion.

Ingredient (Q) is a pigment. For purposes of this application, the term ‘pigment’ includes any ingredient used to impart color to a reaction product of a composition described herein. The amount of pigment depends on various factors including the type of pigment selected and the desired degree of coloration of the reaction product. For example, the composition may comprise 0 to 20%, alternatively 0.001% to 5%, of a pigment based on the weight of all ingredients in the composition. Examples of suitable pigments for ingredient (Q) are commercially available and are exemplified by those described, for example, in PCT Publication No. WO2013/009836.

The composition may optionally further comprise up to 5%, alternatively 1% to 2 based on the weight of the composition of ingredient (R) a rheological additive for modifying rheology of the composition. Rheological additives are known in the art and are commercially available. Examples of suitable rheological additives include polyamides, hydrogenated castor oil derivatives, metal soaps, microcrystalline waxes, and combinations thereof. Examples of suitable rheological additives for ingredient (R) are exemplified by those described, for example, in PCT Publication No. WO2013/009836.

The amount of ingredient (R) depends on various factors including the specific rheological additive selected and the selections of the other ingredients of the composition. However, the amount of ingredient (R) may range from 0 parts to 20 parts, alternatively 1 part to 15 parts, and alternatively 1 part to 5 parts based on the weight of the composition. Ingredient (R) may be one rheological additive. Alternatively, ingredient (R) may comprise two or more different rheological additives.

A vehicle (e.g., a solvent and/or diluent) may be used in the composition. Vehicle may facilitate flow of the composition and introduction of certain ingredients, such as silicone resin. Vehicles used herein are those that help fluidize the ingredients of the composition but essentially do not react with any of these ingredients. Vehicle may be selected based on solubility the ingredients in the composition and volatility. The solubility refers to the vehicle being sufficient to dissolve and/or disperse ingredients of the composition. Volatility refers to vapor pressure of the vehicle. If the vehicle is too volatile (having too high vapor pressure) bubbles may form in the composition at the application temperature, and the bubbles may cause cracks or otherwise weaken or detrimentally affect properties of the cured product. However, if the vehicle is not volatile enough (too low vapor pressure) the vehicle may remain as a plasticizer in the reaction product of the composition, or the amount of time for the reaction product to develop physical properties may be longer than desired.

Suitable vehicles include polyorganosiloxanes with suitable vapor pressures, such as hexamethyldisiloxane, octamethyltrisiloxane, hexamethylcyclotrisiloxane, and other low molecular weight polyorganosiloxanes, such as 0.5 to 1.5 centiStoke (cSt) Dow Corning® 200 Fluids and DOW CORNING® OS FLUIDS, which are commercially available from Dow Corning Corporation of Midland, Mich., U.S.A.

Alternatively, the vehicle may be an organic solvent. The organic solvent can be an alcohol such as methanol, ethanol, isopropanol, butanol, or n-propanol; a ketone such as acetone, methylethyl ketone, or methyl isobutyl ketone; an aromatic hydrocarbon such as benzene, toluene, or xylene; an aliphatic hydrocarbon such as heptane, hexane, or octane; a glycol ether such as propylene glycol methyl ether, dipropylene glycol methyl ether, propylene glycol n-butyl ether, propylene glycol n-propyl ether, or ethylene glycol n-butyl ether, a halogenated hydrocarbon such as dichloromethane, 1,1,1-trichloroethane or methylene chloride; chloroform; dimethyl sulfoxide; dimethyl formamide, acetonitrile; tetrahydrofuran; white spirits; mineral spirits; naphtha; n-methyl pyrrolidone; or a combination thereof.

The amount of vehicle can depend on various factors including the type of vehicle selected and the amount and type of other ingredients selected for the composition. However, the amount of vehicle may range from 1% to 99%, alternatively 2% to 50%, based on the weight of the composition.

The composition may optionally further comprise ingredient (T) a tackifying agent. The tackifying agent may comprise an aliphatic hydrocarbon resin such as a hydrogenated polyolefin having 6 to 20 carbon atoms, a hydrogenated terpene resin, a rosin ester, a hydrogenated rosin glycerol ester, or a combination thereof. Tackifying agents are commercially available and are described, for example, in PCT Publication No. WO 2013/009836.

The composition may optionally further comprise ingredient (U), a corrosion inhibitor. Examples of suitable corrosion inhibitors include benzotriazole, mercaptabenzotriazole and commercially available corrosion inhibitors such as 2,5-dimercapto-1,3,4-thiadiazole derivative (CUVAN® 826) and alkylthiadiazole (CUVAN® 484) from R. T. Vanderbilt of Norwalk, Conn., U.S.A. When present, the amount of ingredient (U) may range from 0.05% to 0.5% based on the weight of the composition.

When selecting ingredients for the composition described above, there may be overlap between types of ingredients because certain ingredients described herein may have more than one function. For example, certain alkoxysilanes may be useful as filler treating agents and as adhesion promoters, certain fatty acid esters may be useful as plasticizers and may also be useful as filler treating agents, carbon black may be useful as a pigment, a flame retardant, and/or a filler, and nonreactive polydiorganosiloxanes such as polydimethylsiloxanes may be useful as extenders and as solvents.

The composition described above may be prepared as a one part composition, for example, by combining all ingredients by any convenient means, such as mixing. For example, a one-part composition may be made by optionally combining (e.g., premixing) the hydroxy-functional compound (B1) and Si—H functional compound (B2), and an extender (E) and mixing the resulting extended base polymer with all or part of the filler (F), and mixing this with a pre-mix comprising the crosslinker (C) and ingredient (A). Other additives such as (O) the anti-aging additive and (Q) the pigment may be added to the mixture at any desired stage. A final mixing step may be performed under substantially anhydrous conditions, and the resulting compositions are generally stored under substantially anhydrous conditions, for example in sealed containers, until ready for use.

Alternatively, the composition may be prepared as a multiple part (e.g., 2 part) composition when a crosslinker is present. In this instance the catalyst and crosslinker are stored in separate parts, and the parts are combined shortly before use of the composition. For example, a two part curable composition may be prepared by combining ingredients comprising (B1) and (B2) to form a first (curing agent) part by any convenient means such as mixing. A second (base) part may be prepared by combining ingredients comprising (A) and (B1) by any convenient means such as mixing. The ingredients may be combined at ambient or elevated temperature and under ambient or anhydrous conditions, depending on various factors including whether a one part or multiple part composition is selected. The base part and curing agent part may be combined by any convenient means, such as mixing, shortly before use. The base part and curing agent part may be combined in relative amounts of base: curing agent ranging from 1:1 to 10:1.

The equipment used for mixing the ingredients is not specifically restricted. Examples of suitable mixing equipment may be selected depending on the type and amount of each ingredient selected. For example, agitated batch kettles may be used for relatively low viscosity compositions, such as compositions that would react to form gums or gels. Alternatively, continuous compounding equipment, e.g., extruders such as twin screw extruders, may be used for more viscous compositions and compositions containing relatively high amounts of particulates. Exemplary methods that can be used to prepare the compositions described herein include those disclosed in, for example, U.S. Patent Publications US 2009/0291238 and US 2008/0300358.

These compositions made as described above may be stable when the stored in containers that protect the compositions from exposure to moisture, but these compositions may react via condensation reaction when exposed to atmospheric moisture. Alternatively, when a low permeability composition is formulated, the composition may cure to form a cured product when moisture is released from a water release agent.

Compositions prepared as described above, and the reaction products thereof, have various uses. The ingredients described above may be used to prepare various types of composition comprising ingredients (A), (B1), and (B2). The composition may further comprise one or more of the additional ingredients described above, depending on the type of composition and the desired end use of the composition and/or the reaction product of the composition. For example, the ingredients and methods described above may be used for chain extension processes to increase viscosity of the base polymer and/or form a gum, for example, when the base polymer has an average of one to two hydrolyzable groups per molecule. Alternatively, the ingredients and methods described above may be used to formulate curable compositions, for example, when the base polymer has two or more hydrolyzable groups per molecule and/or a crosslinker is present in the composition. The compositions described herein may be reacted by condensation reaction by exposure to moisture. For example, the compositions may react via condensation reaction when exposed to atmospheric moisture. Alternatively, the composition react moisture is released from a water release agent, when a water release agent is present. Each composition described herein reacts to form a reaction product. The reaction product may have a form selected from a gum, a gel, a rubber, or a resin.

### Examples

These examples are intended to illustrate some embodiments of the invention and should not be interpreted as limiting the scope of the invention set forth in the claims. Reference examples should not be deemed to be prior art unless so indicated. The following ingredients were used in the examples below.

The metal precursors were abbreviated as follows: Zn-1 was Zn(2-ethylhexanoate)₂ (purchased from Gelest), Zn-2 was diethyl zinc (10 wt % solution in hexane purchased from Strem Chemical), and Zn-3 was zinc bis (bistrimethylsilyl)amide) (purchased from Sigma-Aldrich), as described above. The ligands were abbreviated as follows: (L1) was N,N,N′,N″,N″-pentamethyldiethylenetriamine, (L2) was N,N,N′,N′-tetraethyldiethylenetriamine, and (L3) was tris(dimethylaminomethyl)phenol, as described above. For comparative purposes, (L4) was diethyl 1,3-diacetonedicarboxylate (purchased from Sigma-Aldrich). A silanol terminated polydimethylsiloxane having a viscosity of 90 cSt to 120 cSt and number average molecular weight, Mw, of 4200 (DMS-S21), and a polymethylhydridosiloxane (HMS-992), which are commercially available from Gelest were used to evaluate catalytic activity. For comparative purposes, a commercially available tin catalyst was used. Bu2Sn(OAc)2 was dibutyltindiacetate.

In example 1, 0.2 M solutions of Zn-1, Zn-2, and Zn-3 were prepared from each zinc precursor with mixed solvent of hexane and THF (1:1 by volume). 0.2 M solutions of ligands (L1), (L2), (L3), and (L4) were also prepared with the mixed solvent of hexane and THF (1:1 by volume). To each 5 mL solution of zinc precursor (Zn-1, Zn-2 or Zn-3), 5 mL of each ligand solution (L1, L2, L3, or L4) was added slowly at room temperature (RT) of 25° C. with agitation. After stirring for 30 minutes at room temperature, each solution was heated at 50° C. for 2 hours. The resulting reaction products were 0.1 M zinc catalyst solutions tested for catalytic activity in example 2.

In example 2, DMS-S21 (3 gm, or 1.43 mmole Si—OH) and HMS-992 (0.085 gm or 1.36 mmole Si—H) and 0.24 gm (or 0.30 mL) zinc catalyst solution (0.03 mmole) was loaded in a 20 ml vial. The resulting solutions were stirred with a magnetic bar and heated at 120° C. The viscosity of each solution increased with hydrogen gas generation, and eventually each solution cured. Time for the solution to become too viscous to stop the stirring of the magnetic bar was recorded and used to distinguish the activity of catalysts. Results are listed in the table below. For comparative purposes, each Zn precursor, each ligand, and a commercially available tin catalyst (dibutyl tin diacetate, 0.05 M, 0.48 gm) were also evaluated in this manner. Table 2 shows the metal precursor and ligand used in example 1 and the cure time achieved in example 2.

TABLE 2
Activity Results.

| | | | | Cure |
|---|---|---|---|---|
| | | | | Time |
| Sample | Metal precursor | Ligand | Catalyst | (min.) |
| 1 | Zn(2-EHA)2, | L1 | Zn-1/L1 | 24 |
| | Zn-1 | | | |
| 2 | Zn(2-EHA)2, | L2 | Zn-1/L2 | 30 |
| | Zn-1 | | | |
| 3 | Zn(2-EHA)2, | L3 | Zn-1/L3 | 15 |
| | Zn-1 | | | |
| 4 (comparative) | Zn(2-EHA)2, | L4 | Zn-1/L4 | 52 |
| | Zn-1 | | | |
| 5 | Et2Zn, Zn-2 | L1 | Zn-2/L1 | 6 |
| 6 | Et2Zn, Zn-2 | L2 | Zn-2/L2 | 10 |
| 7 | Et2Zn, Zn-2 | L3 | Zn-2/L3 | 2 |
| 8 (comparative) | Et2Zn, Zn-2 | L4 | Zn-2/L4 | 17 |
| 9 | Zn[N(SiMe3)2]2, | L1 | Zn-3/L1 | 22 |
| | Zn-3 | | | |
| 10 | Zn[N(SiMe3)2]2, | L2 | Zn-3/L2 | 25 |
| | Zn-3 | | | |
| 11 | Zn[N(SiMe3)2]2, | L3 | Zn-3/L3 | 2 |
| | Zn-3 | | | |
| 12 (comparative) | Zn[N(SiMe3)2]2, | L4 | Zn-3/L4 | 28 |
| | Zn-3 | | | |
| 13 (comparative) | Zn-1 | none | n/a | >1000 |
| 14 (comparative) | Zn-2 | none | n/a | 53 |
| 15 (comparative) | Zn-3 | none | n/a | 57 |
| 16 (comparative) | none | L1 | L1 | >3000 |
| 17 (comparative) | none | L2 | L2 | >3000 |
| 18 (comparative) | none | L3 | L3 | >3000 |
| 19 (comparative) | none | L4 | L4 | >3000 |
| 20 (comparative) | none | none | Bu2Sn(OAc)2 | 23 |

In Table 2, n/a means not applicable. This denotes where either a precursor or a ligand was tested for catalytic activity, without a reaction product described above as ingredient (A).

Examples shows that all of the combinations tested produced faster cure time (exhibited catalytic activity) than the ligand alone or the zinc precursor alone. All of the combinations of zinc precursor and ligand tested also had comparable or faster cure than dibutyl tin diacetate under the same conditions. Furthermore, samples 1-3, 5-7, and 9-11 (Table 2) as compared to comparative examples 4, 8, and 12, respectively, show that use of an aminofunctional ligand produced the benefit of faster cure time as compared to use of a ligand that is not aminofunctional tested under the same conditions.

In example 3, Zn-1 (5.21 g, 14.8 mmole) was dissolved in 10 mL toluene in dry box. L3 (3.922 g or 14.8 mmole) was dissolved in 10 mL toluene and added slowly into the Zn-1 solution at room temperature under agitation with a magnetic bar at 500 rpm in the dry box. The solution was stirred at RT for 30 minutes and then heated at 60° C. for 2 hours. The resulting solution was evacuated, which removed solvent. Toluene (37 mL) was added to dissolve the reaction product to a concentration of ≧0.4 M solution.

In example 4, a solution of 10% Zn-2 in hexane (6.751 g or 5.46 mmol) was diluted in 10 mL toluene in a dry box. L3 (1.45 g or 5.46 mmol) was dissolved in 10 mL toluene and added slowly into the Zn-2 solution, which was agitated at 500 rpm in the dry box. Ethane gas was generated during the addition of the ligand solution. The solution was stirred at RT for 30 minutes and then heated at 60° C. for 2 hours. The resulting solution was evacuated, which removed solvent. Toluene (13.65 mL) was added to dissolve the reaction product to a concentration of ≧0.4 M solution.

In example 5, the reaction products prepared in examples 3 and 4 were evaluated for catalytic activity. DMS-S21 (6 g corresponding to 2.86 mmol Si—OH) and HMS-992 (0.3 g corresponding to 4.6 mmol Si—H) and 0.12 g zinc catalyst solution from example 3 or 4 (˜0.05 mmol) were combined and mixed well. Samples of the resulting solutions (0.5 mL) were spread on an aluminum dish to makes films 0.25 mm thick. The samples were heated in an oven at elevated temperature. Cure was evaluated at different times and temperatures, and the results are in Table 3, below.

TABLE 3

| Sample | Zn catalysts | Temperature (C.) | Time | Comment |
|---|---|---|---|---|
| 21 | Zn-2/L3 | 185 | 30 sec | Cured |
| 22 | Zn-2/L3 | 185 | 20 sec | Cured |
| 23 | Zn-2/L3 | 185 | 15 sec | Not cured |
| 24 | Zn-2/L3 | 150 | 30 sec | cured |
| 25 | Zn-1/L3 | 185 | 2 min. | Cured |
| 26 | Zn-1/L3 | 185 | 1.5 min. | cured |
| 27 | Zn-1/L3 | 185 | 1 min. | not cured, |
| 28 | Zn-1/L3 | 160 | 3 min. | Cured |
| 29 | Zn-1/L3 | 160 | 2 min. | cured |
| 30 | Zn-1/L3 | 160 | 1.5 min. | not cured, |

In example 6, comparative sample 31 was prepared by mixing 26.4 g silanol-terminated polymer (Dow Corning Syl-Off 2794), 0.5 g polymethylhydridosiloxane (Dow Corning 7048), 0.9 g methyl dimethylaminoethoxy siloxanes (Dow Corning 2-7131), 125.8 g heptane and 94.7 g toluene to form a solution. Dibutyltindiacetate in an amount of 1.35 g was added into the solution and mixed. The resulting paper coating composition was coated on a Corona treated Loparex PCK Grade paper using a #10 rod. The coated paper was heated in an oven at 230° F. for 30 sec. As soon as the paper was removed from the oven, a small piece of the paper was characterized for immediate extractable silicone and rub-off silicone retention. Post cure was also characterized by measuring the extractable silicone after leaving the oven cured paper at ambient temperature for 7 days. Results showed that immediate extractable silicone, rub-off retention and post cure were 8.5%, 97.8% and 4.1%, respectively. To measure extractable silicone, after the coating was prepared as described above, a piece of the coated paper was dipped in solvent and x-rayed to see how much coating was left.

Sample 32 was prepared by making the solution as described above for comparative sample 31, except 9 g of ≧0.4 M Zn-1/L3 catalyst (described above) was added to the solution and mixed. The resulting paper coating composition was coated on paper, heated, and tested as described above for comparative sample 31. Results showed that immediate extractable silicone, rub-off retention and post cure were 100%, 24.7% and 3.4%, respectively.

Sample 33 was prepared by making the solution as described above for comparative sample 31, except, 9 g 0.4 M Zn-2/L3 catalyst was added and mixed The resulting paper coating composition was coated on paper, heated, and tested as described above for comparative sample 31. Results showed that immediate extractable silicone, rub-off retention and post cure were 22%, 98.8% and 5.2%, respectively.

Comparative Sample 34 was prepared as described above for comparative sample 31. The resulting coating composition was coated on a UPM White Glassine paper using a #10 rod. The coated paper was heated in an oven at 350° F. for 15 sec. Results showed that immediate extractable silicone, rub-off retention and post cure were 11.0%, 91.1% and 2.9%, respectively.

Sample 35 was prepared as described above for comparative sample 31, except 9 g 0.4 M Zn-1/L3 catalyst was added. The resulting coating composition was coated on paper, heated, and evaluated using the same procedure as for comparative sample 34. Results showed that immediate extractable silicone, rub-off retention and post cure were 8.1%, 98.7% and 4.2%, respectively.

Sample 36 was prepared as described above for comparative sample 31, except 9 g 0.4 M Zn-2/L3 catalyst was added. The resulting coating composition was coated on paper, heated, and evaluated using the same procedure as for comparative sample 34. Results showed that immediate extractable silicone, rub-off retention and post cure were 26.8%, 87.9% and 4.5%, respectively.

Results from Examples 6 are summarized in Table 4, below.

TABLE 4

| | | | Immediate | Rub-off | Post |
|---|---|---|---|---|---|
| | | Cure | extractable | retention | cure |
| Samples | Catalysts | Temp | silicone (%) | (%) | (%) |
| Compar- | Bu2Sn(OAc)2 | 230 F. | 8.5 | 97.8 | 4.1 |
| ative 31 | | | | | |
| 32 | Zn-1/L3 | 230 F. | 100 | 24.7 | 3.4 |
| 33 | Zn-2/L3 | 230 F. | 22.0 | 98.8 | 5.2 |
| Compar- | Bu2Sn(OAc)2 | 350 F. | 11.0 | 91.1 | 2.9 |
| ative 34 | | | | | |
| 35 | Zn-1/L3 | 350 F. | 8.1 | 98.7 | 4.2 |
| 36 | Zn-2/L3 | 350 F. | 26.8 | 87.9 | 4.5 |

In example 7, catalysts were evaluated for activity with an organic hydroxy functional compound. Samples were prepared by combining 5 g glycerol propoxylate (MW=1500, purchased from Sigma Aldrich, 0.72 g polymethylhydridosiloxane (HMS-992 from Gelest), and a catalyst. The resulting composition was loaded in a 20 mL vial with a magnetic stir bar. The mixed solution was heated at 120° C. with agitation. In sample 37, the catalyst was 0.08 g Zn-1/L3. Gas bubbles were generated during the reaction, and foam was generated to fill the whole vial within 3 minutes. In sample 38, the catalyst was 0.04 g Zn-2/L3. Gas bubbles were generated during reaction, and foam was generated to fill the whole vial within 5 minutes.

In example 8, catalysts were added to commercially available emulsions to evaluate catalytic activity. XIAMETER® MEM-0075 Emulsion was an emulsion of polymethylhydridosiloxane in water and XIAMETER® MEM-1785 was an emulsion of silanol terminated polydimethylsiloxane in water. Zinc compounds were used to catalyze the crosslinking of those two emulsion materials in thin films. A five point scale, shown below in Table 5, was used to distinguish the degree of crosslinking of the films.

TABLE 5

| Degree of crosslinking | Description |
|---|---|
| 1 | Film similar to liquid |
| 2 | Scratch to the bottom |
| 3 | Some trace on surface |
| 4 | Little trace on surface |
| 5 | No trace on surface |

Samples were prepared by mixing 0.1 g MEM-0075, 5 g MEM-1785 and a catalyst. Comparative sample 40 contained 0.12 g of the precursor Zn-1 [which was 0.1 M Zn(2-EHA)2]. The sample was mixed with a magnetic stir bar at 600 rpm for 5 min. The resulting mixed solution (1 mL) was spread on an aluminum dish (2.5 inches in diameter) and was placed in a hood for 3 days under ambient conditions to vaporize water and solvent. The aluminum dish containing the resulting silicone solution was heated at 150° C. for 5 min. According to the ranking scale in Table 7, the surface of the siloxane film was scratched with a spatula to give ranking #1 for the film dried at room temperature and #2 for the film after heating at 150° C. for 5 min. Samples 41-46 were prepared similarly, using different catalysts, as shown in Table 6, below.

TABLE 6

| | | | | | | Crosslinking | Crosslinking |
|---|---|---|---|---|---|---|---|
| | MEM- | MEM- | | Catalyst | Catalyst | at room | at 150 C. for |
| Samples | 0075 | 1785 | Catalyst | conc. | amount | temp | 5 min |
| 40 | 0.1 g | 5 g | Zn-1 | 0.1M | 0.48 gm | 1 | 2 |
| (comparative) | | | precursor | | | | |
| 41 | 0.1 g | 5 g | Zn-1/L1 | 0.05M | 0.24 gm | 2 | 3 |
| 42 | 0.1 g | 5 g | Zn-1/L1 | 0.05M | 0.48 gm | 3 | 4 |
| 43 | 0.1 g | 5 g | Zn-1/L3 | 0.05M | 0.24 gm | 3 | 5 |
| 44 | 0.1 g | 5 g | Zn-1/L3 | 0.05M | 0.48 gm | 4 | 5 |
| 45 | 0.1 g | 5 g | Bu2Sn(OAc)2 | 0.05M | 0.24 gm | 1 | 4 |
| 46 | 0.1 g | 5 g | DC Syl-Off ®- | | 0.05 gm | 2 | 5 |
| | | | 1171A | | | | |

In example 9, he Zn catalysts Zn-1C and Zn-2C prepared above were diluted to 0.025 M in toluene in vials. An amount of catalyst solution (either 0.24 g or 0.48 g) was mixed with 0.136 g methyltrimethoxysilane and 2.1 g Si—OH terminated polydimethylsiloxane (DMS-S21 with viscosity 90-120 cSt) in each vial. The resulting vials were tilted at 80 degrees and placed in controlled humidity oven and exposed in 50 relative humidity (RH) at 30° C.

After 24 hours and 48 hours in the humidity oven, the vials were removed from the humidity oven, and visual viscosity observations were recorded. The 48 hour visual viscosity measurements were determined by side to side visual comparison of the samples with vials containing different viscosity reference standards. The measurements were performed 48 hours after the samples were first exposed to moisture. The visual viscosity measurement value of each sample was assigned based on the vial of the reference standard it most closely matched. The reference standards were DOW CORNING® 200 fluids (“200 Fluid”) of different viscosities, which were commercially available from Dow Corning Corporation of Midland, Mich., U.S.A. The visual viscosity description and standard to which it corresponded are shown below in Table 7. A value of ≧0 or 1 indicated that the sample did not exhibit condensation reaction in the 48 hours. A value of 2 to 5 indicated that condensation reaction increasingly occurred. Replicate experiments were subject to normal variation due to various factors, such as the operator performing the visual viscosity measurement and whether the replicate experiments were performed at different times.

TABLE 7
Visual Viscosity Measurement

| | |
|---|---|
| 0- No Change | 50 cSt 200 Fluid |
| 1- Slightly viscous | 500 cSt 200 Fluid |
| 2- Viscous | 1000 cSt 200 Fluid |
| 3- Very viscous | 5000 cSt 200 Fluid |
| 4- Extremely viscous | 50000 cSt 200 Fluid |
| 5- No flow | No flow observed |

Results from the condensation catalyzed by the Zinc catalysts tested are listed in Table 8 below. Dibutyltindilaurate was used as control with concentration 0.025 M in toluene.

TABLE 8

| | | | Viscosity | Viscosity |
|---|---|---|---|---|
| Samples | catalyst | amount | (24 hours) | (48 hours) |
| 47 | Zn-1/L3 | 0.24 g | 1 | 2 |
| 48 | Zn-1/L3 | 0.48 g | 2 | 5 |
| 49 | Zn-2/L3 | 0.24 g | 2 | 5 |
| 50 | Zn-2/L3 | 0.48 g | 5 | 5 |
| 51 (comparative) | Bu2Sn(laurate)2 | 0.24 g | 3 | 5 |

These examples show that the catalysts described above for ingredient (A) and tested as described herein are capable of catalyzing condensation reaction. The composition described herein may be free of tin catalysts, such as those described above. Without wishing to be bound by theory, it is thought that the catalysts described herein as ingredient (A) may provide alternative, comparable, or better cure performance in some condensation reaction curable compositions, as compared to the same composition containing a tin catalyst.

Example 6 shows that the catalysts described above for ingredient (A) may be useful in paper coatings, particularly under the conditions tested in samples 32, 33, 35, and 36. The inventors surprisingly found that eliminating isopropanol from the paper coating composition resulted in improved performance. Ingredient (A) described herein may be used in paper coating compositions that are free of alcohol solvents, alternatively, free of isopropanol.

In example 10, 0.2 M solutions of Zn-1 and Zn-2 were prepared from each zinc precursor with mixed solvent of hexane and THF (1:1 by volume). 0.2 M solutions of ligands (L6), (L7), (L8), (L9), (L10), (L11), and (L12), shown above in Table 1-B, were also prepared with the mixed solvent of hexane and THF (1:1 by volume). To each 5 mL solution of zinc precursor (Zn-1 or Zn-2), 5 mL of each ligand solution (L6), (L7), (L8), (L9), (L10), (L11), or (L12), was added slowly at room temperature (RT) of 25° C. with agitation. After stirring for 30 minutes at room temperature, each solution was heated at 50° C. for 2 hours. The resulting reaction products were 0.1 M zinc catalyst solutions tested for catalytic activity in example 11.

In example 11, DMS-S21 (3 gm, or 1.43 mmole Si—OH) and HMS-992 (0.085 gm or 1.36 mmole Si—H) and 0.24 gm (or 0.30 mL) zinc catalyst solution (0.03 mmole) was loaded in a 20 ml vial. The resulting solutions were stirred with a magnetic bar and heated at 120° C. The viscosity of each solution increased with hydrogen gas generation, and eventually each solution cured. Time for the solution to become too viscous to stop the stirring of the magnetic bar was recorded and used to distinguish the activity of catalysts. Results are listed in the table below. For comparative purposes, each Zn precursor, each ligand, and a commercially available tin catalyst (dibutyl tin diacetate, 0.05 M, 0.48 gm) were also evaluated in this manner. Table 9 shows the metal precursor and ligand used in example 10 and the cure time achieved in example 11.

TABLE 9
Cure time (min) of samples in example 11 for condensation of
polymethylhydrosiloxane and dimethylsilanol-terminated PDMS
at 120° C.

| | No Zn | | |
|---|---|---|---|
| Ligand no. | precursor | Zn-1 | Zn-2 |
| L6 | 30 | 10 | 8 |
| L7 | 19 | 16 | 28 |
| L8 | 16 | 5 | 3 |
| L9 | 16 | 18 | 15 |
| L10 | 20 | 6 | 8 |
| L11 | 35 | 2 | 1 |
| L12 | 16 | 51 | 5 |
| No Ligand | 40 | 84 | 84 |

1. A composition comprising:
(A) a catalytically effective amount of a reaction product, where the reaction product is prepared by a method comprising:
reacting ingredients comprising
i) a zinc precursor of general formula Zn-Aₐ, where each A is independently a displaceable substituent, and subscript a is 1 to maximum valence of Zn; and
ii) a ligand comprising two or more amino-functional moieties of general formula (ii): 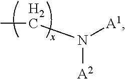
where subscript x is 1 or 2, and A¹ and A² are each independently selected from monovalent hydrocarbon groups and monovalent halogenated hydrocarbon groups;
(B1) a hydroxy functional compound having an average, per molecule, of one or more hydroxy moieties, and
(B2) a Si—R⁵⁰ functional compound having an average, per molecule, of one or more R⁵⁰ moieties, where R⁵⁰ is a hydrogen atom or a hydrocarbonoxy group;
where
ingredient (A) is capable of catalyzing a condensation reaction of the hydroxy moiety on ingredient (B1) and the R⁵⁰ moiety on ingredient (B2).

2. The composition of claim 1, where A in the zinc precursor is selected from a silyl amide group, an alkyl group, and a carboxylic ester group.

3. The composition of claim 1, where the ligand is a triamino-functional compound of formula (iii): 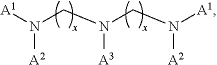
where A³ is selected from a hydrogen atom and an alkyl group of 1 to 6 carbon atoms.

4. The composition of claim 3, where the ligand is selected from N,N,N′,N″,N″-pentamethyldiethylenetriamine or N,N,N′,N′-tetraethyldiethylenetriamine.

5. The composition of claim 1, where the ligand has general formula (iv): 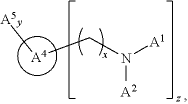
where group A⁴ is a carbocyclic group having at least 3 carbon atoms covalently bonded in a ring, subscript y is at least 1, subscript z is at least 2, and a quantity (y+z) represents valence of A⁴, where the carbocyclic group has a moiety of formula A⁵ and the moieties of general formula (ii) 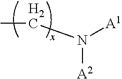
covalently bonded to carbon atoms in the ring; and each A⁵ is independently a hydrogen atom or a hydroxy group.

6. The composition of claim 5, where the ligand is 2,4,6-tris(dimethylaminomethyl)phenol.

7. The composition of claim 1 further comprising heating the zinc precursor and the ligand.

8. (canceled)

9. The composition of claim 1, further comprising at least one additional ingredient distinct from ingredients (A), (B1), and (B2), where the at least one additional ingredient is selected from the group consisting of: (C) a crosslinker; (D) a drying agent; (E) an extender, a plasticizer, or a combination thereof; (F) a filler; (G) a treating agent; (H) a biocide; (J) a flame retardant; (K) a surface modifier; (L) a chain lengthener; (M) an endblocker; (N) a nonreactive binder; (O) an anti-aging additive; (P) a water release agent; (Q) a pigment; (R) a rheological additive; (S) a vehicle; (T) a tackifying agent; (U) a corrosion inhibitor; and a combination thereof.

10.-11. (canceled)

12. A paper coating composition comprising:
(A) a catalytically effective amount of a reaction product a reaction product, where the reaction product is prepared by a method comprising:
reacting ingredients comprising
i) a zinc precursor of general formula Zn-Aₐ, where each A is independently a displaceable substituent, and subscript a is 1 to maximum valence of Zn; and
ii) a ligand comprising two or more amino-functional moieties of general formula (ii): 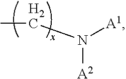
where subscript x is 1 or 2, and A¹ and A² are each independently selected from monovalent hydrocarbon groups and monovalent halogenated hydrocarbon groups;
(B1) a disilanol-functional gum, and
(B2) a polydiorganosiloxane of unit formula (I) (R⁵⁰_{d}R²_{(3-d)}SiR³_{1/2})₂(R²₂SiO_{2/2})ₑ(R⁵⁰R²SiO_{2/2})_{f}, where each R⁵⁰ is a hydrogen atom, each R² is independently a monovalent organic group, each R³ is independently an oxygen atom or a divalent hydrocarbon group, each subscript d is independently 0, 1, 2, or 3, e is ≧0, f≧0, and a quantity (e+f) is an integer having a value sufficient to provide the polydiorganosiloxane with a viscosity of at least 100 mPa·s at 25° C.; wherein the paper coating composition is free of alcohol.

13. A composition comprising:
(A) a catalytically effective amount of a reaction product, where the reaction product is prepared by a method comprising:
reacting ingredients comprising
i) a zinc precursor of general formula Zn-Aₐ, where each A is independently a displaceable substituent, and subscript a is 1 to maximum valence of Zn; and
ii) a ligand comprising one or more amino-functional moieties of general formula (ii): 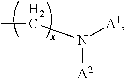
where subscript x is 1 or 2, and A¹ and A² are each independently selected from monovalent hydrocarbon groups and monovalent halogenated hydrocarbon groups;
(B1) a hydroxy functional compound having an average, per molecule, of one or more hydroxy moieties, and
(B2) a Si—R⁵⁰ functional compound having an average, per molecule, of one or more R⁵⁰ moieties, where R⁵⁰ is a hydrogen atom or a hydrocarbonoxy group;
where
ingredient (A) is capable of catalyzing a condensation reaction of the hydroxy moiety on ingredient (B1) and the R⁵⁰ moiety on ingredient (B2).

14. The composition of claim 13, where A in the zinc precursor is selected from a silyl amide group, an alkyl group, and a carboxylic ester group.

15. The composition of claim 13, where the ligand is a compound of general formula (v): 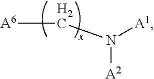
where A⁶ is a monovalent heteroatom containing group selected from a monovalent halogenated hydrocarbon group; an amino group of formula: 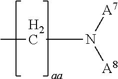
where A⁷ is hydrogen or A¹, A⁸ is hydrogen or A², and subscript aa is 0 to 2; a hydroxyl functional group of formula 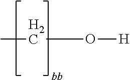
where subscript bb is 0 to 2; and an amino and hydroxyl functional group of formula 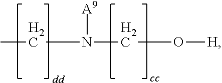
where subscript cc is 1 or 2, subscript dd is 1 or 2, and A⁹ is hydrogen or alkyl.

16. The composition of claim 15, where the ligand is selected from

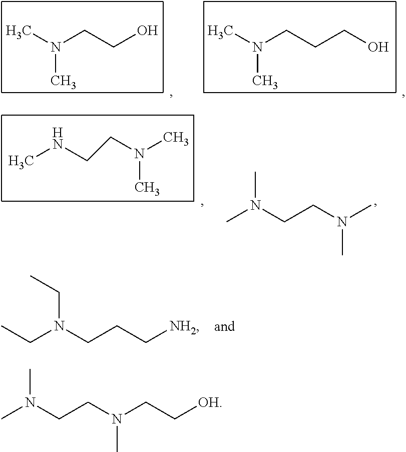

17. The composition of claim 13, further comprising heating the zinc precursor and the ligand.

18. (canceled)

19. The composition of claim 13, further comprising at least one additional ingredient distinct from ingredients (A), (B1), and (B2), where the at least one additional ingredient is selected from the group consisting of: (C) a crosslinker; (D) a drying agent; (E) an extender, a plasticizer, or a combination thereof; (F) a filler; (G) a treating agent; (H) a biocide; (J) a flame retardant; (K) a surface modifier; (L) a chain lengthener; (M) an endblocker; (N) a nonreactive binder; (O) an anti-aging additive; (P) a water release agent; (Q) a pigment; (R) a rheological additive; (S) a vehicle; (T) a tackifying agent; (U) a corrosion inhibitor; and a combination thereof.

20.-21. (canceled)

22. A composition comprising:
(A) a catalytically effective amount of a reaction product, where the reaction product is prepared by a method comprising:
reacting ingredients comprising
i) a zinc precursor of general formula Zn-Aₐ, where each A is independently a displaceable substituent, and subscript a is 1 to maximum valence of Zn; and
ii) a ligand of general formula (vi): 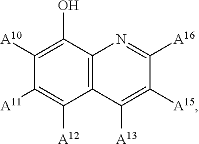
where A¹⁰, A¹¹, A¹², A¹³, A¹⁴, A¹⁵, and A¹⁶ are each independently selected from hydrogen and an alkyl group, such as methyl, ethyl, propyl or butyl;
(B1) a hydroxy functional compound having an average, per molecule, of one or more hydroxy moieties, and
(B2) a Si—R⁵⁰ functional compound having an average, per molecule, of one or more R⁵⁰ moieties, where R⁵⁰ is a hydrogen atom or a hydrocarbonoxy group;
where
ingredient (A) is capable of catalyzing a condensation reaction of the hydroxy moiety on ingredient (B1) and the R⁵⁰ moiety on ingredient (B2).

23. The composition of claim 22, where A in the zinc precursor is selected from a silyl amide group, an alkyl group, and a carboxylic ester group.

24. The composition of claim 22, where the ligand is

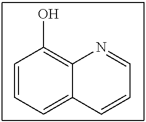 [SMILES: Oc1cccc2cccnc12]

25. The composition of claim 22, further comprising heating the zinc precursor and the ligand.

26. (canceled)

27. The composition of claim 22, further comprising at least one additional ingredient distinct from ingredients (A), (B1), and (B2), where the at least one additional ingredient is selected from the group consisting of: (C) a crosslinker; (D) a drying agent; (E) an extender, a plasticizer, or a combination thereof; (F) a filler; (G) a treating agent; (H) a biocide; (J) a flame retardant; (K) a surface modifier; (L) a chain lengthener; (M) an endblocker; (N) a nonreactive binder; (O) an anti-aging additive; (P) a water release agent; (Q) a pigment; (R) a rheological additive; (S) a vehicle; (T) a tackifying agent; (U) a corrosion inhibitor; and a combination thereof.

28.-29. (canceled)
